(19) United States
(12) Patent Application Publication
(10) Pub. No.: US 2025/0234220 A1
(43) Pub. Date: Jul. 17, 2025

(54) SYNCHRONIZATION SIGNAL BLOCK MEASUREMENT GAPS IN MULTIPLE LAYERS

(71) Applicant: QUALCOMM Incorporated, San Diego, CA (US)

(72) Inventors: Muhammad Nazmul ISLAM, Littleton, MA (US); Chun-Hao HSU, San Jose, CA (US); Carsten Aagaard PEDERSEN, Bolton, MA (US); Murali MENON, Acton, MA (US); Prashant SHARMA, San Marcos, CA (US); Scott HOOVER, Del Mar, CA (US); Michael LOPEZ, East Walpole, MA (US); Masoud AZMOODEH, San Diego, CA (US); Parthiban RAJENDRAN, Hyderabad (IN); Yongjun KWAK, San Diego, CA (US)

(21) Appl. No.: 18/854,919

(22) PCT Filed: Apr. 5, 2023
(86) PCT No.: PCT/US2023/017528

§ 371 Date: Oct. 7, 2024

(30) Foreign Application Priority Data
Apr. 25, 2022 (IN) 202241024358

(51) Int. Cl. H04W 24/08; H04L 5/00; H04L 41/0896

(52) U.S. Cl. CPC H04W 24/08; H04L 5/0048; H04L 41/0896

(57) ABSTRACT

Methods, systems, and devices for wireless communication are described. A user equipment (UE) may transmit an indication of UE capability of performing reference signal measurements outside an active bandwidth part. The UE may receive signaling identifying first and second measurement gap configurations for one or more radio resource management procedures and one or more beam tracking or mobility procedures, respectively. The configurations may define respective pattern of measurement occasions, and the UE may perform reference signal measurements during a set of reference signal measurement occasions that is identified based at least in part on the first pattern of measurement occasions, the second pattern of measurement occasions, and a minimum gap separation threshold applicable between measurement occasions of the first pattern and measurement occasions of the second pattern.

### CROSS REFERENCE

The present application is a 371 national stage filing of International PCT Application No. PCT/US2023/017528 by ISLAM et al. entitled “SYNCHRONIZATION SIGNAL BLOCK MEASUREMENT GAPS IN MULTIPLE LAYERS,” filed Apr. 5, 2023; and claims priority to Indian Patent Application number 202241024358 by Islam et al., entitled “SYNCHRONIZATION SIGNAL BLOCK MEASURMENT GAPS IN MULTIPLE LAYERS,” filed Apr. 25, 2022, each of which is assigned to the assignee hereof, and each of which is expressly incorporated by reference in its entirety herein.

### TECHNICAL FIELD

The following relates to wireless communication, including synchronization signal block measurement gaps in multiple layers.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may be configured to perform measurements of reference signals for various procedures. For example, a UE may measure synchronization signal blocks (SSBs) in neighboring cells in high mobility scenarios for radio resource management (RRM) procedures. These measurements may be performed according to configurations received from network entities.

### SUMMARY

The described techniques relate to improved methods, systems, devices, and apparatuses that support synchronization signal block measurement gaps in multiple layers. For example, the described techniques provide for a user equipment (UE) transmitting an indication of UE capability of performing reference signal measurements outside an active bandwidth part. The UE may receive signaling identifying first and second measurement gap configurations for one or more radio resource management procedures and one or more beam tracking or mobility procedures, respectively. The configurations may define respective pattern of measurement occasions, and the UE may perform reference signal measurements during a set of reference signal measurement occasions that is identified based at least in part on the first pattern of measurement occasions, the second pattern of measurement occasions, and a minimum gap separation threshold applicable between measurement occasions of the first pattern and measurement occasions of the second pattern.

A method for wireless communication at a user equipment (UE) is described. The method may include receiving signaling identifying a first measurement gap configuration defining a first pattern of measurement occasions for reference signal measurements outside an active bandwidth part for the UE and associated with one or more radio resource management procedures, receiving signaling identifying a second measurement gap configuration defining a second pattern of measurement occasions for reference signal measurements outside the active bandwidth part for the UE and associated with one or more beam mobility or tracking procedures, and performing the reference signal measurements during a set of reference signal measurement occasions that is identified based on the first pattern of measurement occasions, the second pattern of measurement occasions, and a minimum gap separation threshold applicable between measurement occasions of the first pattern and measurement occasions of the second pattern.

An apparatus for wireless communication at a UE is described. The apparatus may include at least one processor, memory coupled with the at least one processor, the memory storing instructions. The instructions may be executable by the at least one processor to cause the UE to receive signaling identifying a first measurement gap configuration defining a first pattern of measurement occasions for reference signal measurements outside an active bandwidth part for the UE and associated with one or more radio resource management procedures, receive signaling identifying a second measurement gap configuration defining a second pattern of measurement occasions for reference signal measurements outside the active bandwidth part for the UE and associated with one or more beam mobility or tracking procedures, and perform the reference signal measurements during a set of reference signal measurement occasions that is identified based on the first pattern of measurement occasions, the second pattern of measurement occasions, and a minimum gap separation threshold applicable between measurement occasions of the first pattern and measurement occasions of the second pattern.

Another apparatus for wireless communication at a UE is described. The apparatus may include means for receiving signaling identifying a first measurement gap configuration defining a first pattern of measurement occasions for reference signal measurements outside an active bandwidth part for the UE and associated with one or more radio resource management procedures, means for receiving signaling identifying a second measurement gap configuration defining a second pattern of measurement occasions for reference signal measurements outside the active bandwidth part for the UE and associated with one or more beam mobility or tracking procedures, and means for performing the reference signal measurements during a set of reference signal measurement occasions that is identified based on the first pattern of measurement occasions, the second pattern of measurement occasions, and a minimum gap separation threshold applicable between measurement occasions of the first pattern and measurement occasions of the second pattern.

A non-transitory computer-readable medium storing code for wireless communication at a UE is described. The code may include instructions executable by at least one processor to receive signaling identifying a first measurement gap configuration defining a first pattern of measurement occasions for reference signal measurements outside an active bandwidth part for the UE and associated with one or more radio resource management procedures, receive signaling identifying a second measurement gap configuration defining a second pattern of measurement occasions for reference signal measurements outside the active bandwidth part for the UE and associated with one or more beam mobility or tracking procedures, and perform the reference signal measurements during a set of reference signal measurement occasions that is identified based on the first pattern of measurement occasions, the second pattern of measurement occasions, and a minimum gap separation threshold applicable between measurement occasions of the first pattern and measurement occasions of the second pattern.

Some examples of the method, apparatuses, and non-transitory computer-readable medium described herein may further include operations, features, means, or instructions for transmitting an indication of a UE capability of performing reference signal measurements outside the active bandwidth part for the UE and according to one or more measurement gap configurations, the UE capability corresponding to the reference signal measurements associated with the one or more beam mobility or tracking procedures, where the signaling identifying the first measurement gap configuration, the signaling identifying the second measurement gap configuration, or both, may be received based on transmitting the indication of the UE capability.

Some examples of the method, apparatuses, and non-transitory computer-readable medium described herein may further include operations, features, means, or instructions for performing a reference signal measurement during a first measurement occasion of the first pattern or a second measurement occasion of the second pattern based on a time separation between the first measurement occasion and the second measurement occasion being less than the minimum gap separation threshold.

Some examples of the method, apparatuses, and non-transitory computer-readable medium described herein may further include operations, features, means, or instructions for selecting either the first measurement occasion or the second measurement occasion for performing the reference signal measurement in accordance with a selection rule that may be applied when the time separation may be less than the minimum gap separation threshold.

Some examples of the method, apparatuses, and non-transitory computer-readable medium described herein may further include operations, features, means, or instructions for selecting either the first measurement occasion or the second measurement occasion for performing the reference signal measurement in accordance with a first priority associated with the first pattern and a second priority associated with the second pattern.

Some examples of the method, apparatuses, and non-transitory computer-readable medium described herein may further include operations, features, means, or instructions for selecting either the first measurement occasion or the second measurement occasion for performing the reference signal measurement based on a beam quality of a serving beam, a beam quality of a non-serving beam, a mobility of the UE, channel conditions, or a combination thereof.

In some examples of the method, apparatuses, and non-transitory computer-readable medium described herein, the beam quality of the serving beam, the beam quality of the non-serving beam, or both may be based on one or more combinations of signal-to-noise ratio, reference signal receive power (RSRP), reference signal received quality (RSRQ), layer one reference signal receive power (L1-RSRP), or a combination thereof.

Some examples of the method, apparatuses, and non-transitory computer-readable medium described herein may further include operations, features, means, or instructions for identifying a collision based on the time separation being less than the minimum gap separation threshold, where the reference signal measurement may be performed during the first measurement occasion or the second measurement occasion based on identifying the collision.

Some examples of the method, apparatuses, and non-transitory computer-readable medium described herein may further include operations, features, means, or instructions for receiving signaling that identifies a selection rule that may be used by the UE to select, for performing the reference signal measurements, either a first measurement occasion of the first pattern or a second measurement occasion of the second pattern when a time separation between the first measurement occasion and the second measurement occasion may be less than the minimum gap separation threshold.

In some examples of the method, apparatuses, and non-transitory computer-readable medium described herein, the minimum gap separation threshold may be based on a measurement occasion periodicity of the first pattern, a measurement occasion periodicity of the second pattern, a measurement occasion length of the first pattern, a measurement occasion length of the second pattern, or a combination thereof.

In some examples of the method, apparatuses, and non-transitory computer-readable medium described herein, the minimum gap separation threshold may be based on a tone spacing, a frequency, a UE capability, or a combination thereof.

Some examples of the method, apparatuses, and non-transitory computer-readable medium described herein may further include operations, features, means, or instructions for receiving signaling indicating the minimum gap separation threshold.

In some examples of the method, apparatuses, and non-transitory computer-readable medium described herein, reference signal measurements may be performed on synchronization signal blocks, channel state information reference signals, or both.

A method for wireless communication at a UE is described. The method may include transmitting an indication of a UE capability of performing reference signal measurements outside an active bandwidth part for the UE and according to one or more measurement gap configurations, the UE capability corresponding to the reference signal measurements associated with one or more beam mobility or tracking procedures, receiving, based on transmitting the indication, signaling identifying a first measurement gap configuration defining a first pattern of measurement occasions for reference signal measurements associated with the one or more beam mobility or tracking procedures, and performing the reference signal measurements during a set of reference signal measurement occasions that is identified based on the first measurement gap configuration.

An apparatus for wireless communication at a UE is described. The apparatus may include at least one processor, memory coupled with the at least one processor, the memory storing instructions. The instructions may be executable by the at least one processor to cause the UE to transmit an indication of a UE capability of performing reference signal measurements outside an active bandwidth part for the UE and according to one or more measurement gap configurations, the UE capability corresponding to the reference signal measurements associated with one or more beam mobility or tracking procedures, receive, based on transmitting the indication, signaling identifying a first measurement gap configuration defining a first pattern of measurement occasions for reference signal measurements associated with the one or more beam mobility or tracking procedures, and perform the reference signal measurements during a set of reference signal measurement occasions that is identified based on the first measurement gap configuration.

Another apparatus for wireless communication at a UE is described. The apparatus may include means for transmitting an indication of a UE capability of performing reference signal measurements outside an active bandwidth part for the UE and according to one or more measurement gap configurations, the UE capability corresponding to the reference signal measurements associated with one or more beam mobility or tracking procedures, means for receiving, based on transmitting the indication, signaling identifying a first measurement gap configuration defining a first pattern of measurement occasions for reference signal measurements associated with the one or more beam mobility or tracking procedures, and means for performing the reference signal measurements during a set of reference signal measurement occasions that is identified based on the first measurement gap configuration.

A non-transitory computer-readable medium storing code for wireless communication at a UE is described. The code may include instructions executable by at least one processor to transmit an indication of a UE capability of performing reference signal measurements outside an active bandwidth part for the UE and according to one or more measurement gap configurations, the UE capability corresponding to the reference signal measurements associated with one or more beam mobility or tracking procedures, receive, based on transmitting the indication, signaling identifying a first measurement gap configuration defining a first pattern of measurement occasions for reference signal measurements associated with the one or more beam mobility or tracking procedures, and perform the reference signal measurements during a set of reference signal measurement occasions that is identified based on the first measurement gap configuration.

In some examples of the method, apparatuses, and non-transitory computer-readable medium described herein, transmitting the UE capability may include operations, features, means, or instructions for transmitting the indication that the UE supports a single measurement gap configuration for reference signal measurements associated with the one or more beam mobility or tracking procedures and reference signal measurements associated with one or more radio resource management procedures.

In some examples of the method, apparatuses, and non-transitory computer-readable medium described herein, the indication specifies that the single measurement gap configuration may be applicable across a set of frequency ranges.

In some examples of the method, apparatuses, and non-transitory computer-readable medium described herein, transmitting the UE capability may include operations, features, means, or instructions for transmitting the indication that the UE supports different measurement gap configurations for reference signal measurements associated with the one or more beam mobility or tracking procedures and for reference signal measurements associated with one or more radio resource management procedures.

In some examples of the method, apparatuses, and non-transitory computer-readable medium described herein, the indication specifies that the different measurement gap configurations may be applicable across a set of frequency ranges.

In some examples of the method, apparatuses, and non-transitory computer-readable medium described herein, transmitting the UE capability may include operations, features, means, or instructions for transmitting the indication that the UE supports a measurement gap configuration for respective frequency ranges of a set of frequency ranges, where the measurement gap configuration applicable to both reference signal measurements associated with the one or more beam mobility or tracking procedures and reference signal measurements associated with one or more radio resource management procedures in the respective frequency range.

In some examples of the method, apparatuses, and non-transitory computer-readable medium described herein, transmitting the UE capability may include operations, features, means, or instructions for transmitting the indication that the UE supports different measurement gap configurations for reference signal measurements associated with the one or more beam mobility or tracking procedures and for reference signal measurements associated with one or more radio resource management procedures and in different frequency ranges of a set of frequency ranges.

Some examples of the method, apparatuses, and non-transitory computer-readable medium described herein may further include operations, features, means, or instructions for receiving signaling identifying a second measurement gap configuration defining a second pattern of measurement occasions for reference signal measurements outside the active bandwidth part for the UE and associated with one or more radio resource management procedures and performing the reference signal measurements during a set of reference signal measurement occasions that may be identified based on the first pattern of measurement occasions, the second pattern of measurement occasions, and a minimum gap separation threshold applicable between measurement occasions of the first pattern and measurement occasions of the second pattern.

In some examples of the method, apparatuses, and non-transitory computer-readable medium described herein, transmitting the UE capability may include operations, features, means, or instructions for transmitting the indication that the UE supports measurement gap configurations differently for the one or more beam mobility and tracking procedures and for one or more radio resource management procedures.

In some examples of the method, apparatuses, and non-transitory computer-readable medium described herein, reference signal measurements may be performed on synchronization signal blocks, channel state information reference signals, or both.

A method for wireless communications at a network entity is described. The method may include transmitting signaling identifying a first measurement gap configuration defining a first pattern of measurement occasions for reference signal measurements outside an active bandwidth part for a UE and associated with one or more radio resource management procedures, transmitting signaling identifying a second measurement gap configuration defining a second pattern of measurement occasions for reference signal measurements outside the active bandwidth part for the UE and associated with one or more beam mobility or tracking procedures, and communicating with the UE in accordance with the first measurement gap configuration, the second measurement gap configuration, or both, based on a minimum gap separation threshold.

An apparatus for wireless communications at a network entity is described. The apparatus may include at least one processor, memory coupled with the at least one processor, the memory storing instructions. The instructions may be executable by the at least one processor to cause the network entity to transmit signaling identifying a first measurement gap configuration defining a first pattern of measurement occasions for reference signal measurements outside an active bandwidth part for a UE and associated with one or more radio resource management procedures, transmit signaling identifying a second measurement gap configuration defining a second pattern of measurement occasions for reference signal measurements outside the active bandwidth part for the UE and associated with one or more beam mobility or tracking procedures, and communicate with the UE in accordance with the first measurement gap configuration, the second measurement gap configuration, or both, based on a minimum gap separation threshold.

Another apparatus for wireless communications at a network entity is described. The apparatus may include means for transmitting signaling identifying a first measurement gap configuration defining a first pattern of measurement occasions for reference signal measurements outside an active bandwidth part for a UE and associated with one or more radio resource management procedures, means for transmitting signaling identifying a second measurement gap configuration defining a second pattern of measurement occasions for reference signal measurements outside the active bandwidth part for the UE and associated with one or more beam mobility or tracking procedures, and means for communicating with the UE in accordance with the first measurement gap configuration, the second measurement gap configuration, or both, based on a minimum gap separation threshold.

A non-transitory computer-readable medium storing code for wireless communications at a network entity is described. The code may include instructions executable by at least one processor to transmit signaling identifying a first measurement gap configuration defining a first pattern of measurement occasions for reference signal measurements outside an active bandwidth part for a UE and associated with one or more radio resource management procedures, transmit signaling identifying a second measurement gap configuration defining a second pattern of measurement occasions for reference signal measurements outside the active bandwidth part for the UE and associated with one or more beam mobility or tracking procedures, and communicate with the UE in accordance with the first measurement gap configuration, the second measurement gap configuration, or both, based on a minimum gap separation threshold.

Some examples of the method, apparatuses, and non-transitory computer-readable medium described herein may further include operations, features, means, or instructions for receiving an indication of a UE capability of performing reference signal measurements outside the active bandwidth part for the UE and according to one or more measurement gap configurations, the UE capability corresponding to the reference signal measurements associated with the one or more beam mobility or tracking procedures, where the signaling identifying the first measurement gap configuration, the signaling identifying the second measurement gap configuration, or both, may be transmitted based on transmitting the indication of the UE capability.

Some examples of the method, apparatuses, and non-transitory computer-readable medium described herein may further include operations, features, means, or instructions for transmitting signaling that identifies a selection rule that may be used by the UE to select, for performing a reference signal measurement, either a first measurement occasion of the first pattern or a second measurement occasion of the second pattern when a time separation between the first measurement occasion and the second measurement occasion may be less than the minimum gap separation threshold.

In some examples of the method, apparatuses, and non-transitory computer-readable medium described herein, the selection rule specifies that the UE may be to use a first priority associated with the first pattern and a second priority associated with the second pattern in selecting between the first measurement occasion and the second measurement occasion for performing the reference signal measurement.

In some examples of the method, apparatuses, and non-transitory computer-readable medium described herein, the selection rule specifies that the UE may be to use a beam quality of a serving beam, a beam quality of a non-serving beam, a mobility of the UE, a channel condition, or a combination thereof, for selecting between the first measurement occasion and the second measurement occasion for performing the reference signal measurement.

Some examples of the method, apparatuses, and non-transitory computer-readable medium described herein may further include operations, features, means, or instructions for identifying a collision between a first measurement occasion of the first pattern and a second measurement occasion of the second pattern based on a time separation between the first measurement occasion and the second measurement occasion being less than the minimum gap separation threshold.

In some examples of the method, apparatuses, and non-transitory computer-readable medium described herein, the minimum gap separation threshold may be based on a measurement occasion periodicity of the first pattern, a measurement occasion periodicity of the second pattern, a measurement occasion length of the first pattern, a measurement occasion length of the second pattern, or a combination thereof.

Some examples of the method, apparatuses, and non-transitory computer-readable medium described herein may further include operations, features, means, or instructions for transmitting signaling indicating the minimum gap separation threshold.

In some examples of the method, apparatuses, and non-transitory computer-readable medium described herein, the minimum gap separation threshold may be based on a tone spacing, a frequency, a UE capability, or a combination thereof.

In some examples of the method, apparatuses, and non-transitory computer-readable medium described herein, reference signal measurements may be performed on synchronization signal blocks, channel state information reference signals, or both.

A method for wireless communication at a network entity is described. The method may include receiving an indication of a UE capability of performing reference signal measurements outside an active bandwidth part for the UE and according to one or more measurement gap configurations, the UE capability corresponding to the reference signal measurements associated with one or more beam mobility or tracking procedures, transmitting, based on the UE capability, signaling identifying a first measurement gap configuration defining a first pattern of measurement occasions for reference signal measurements associated with the one or more beam mobility or tracking procedures, and communicating with the UE based on the first measurement gap configuration.

An apparatus for wireless communication at a network entity is described. The apparatus may include at least one processor, memory coupled with the at least one processor, the memory storing instructions. The instructions may be executable by the at least one processor to cause the network entity to receive an indication of a UE capability of performing reference signal measurements outside an active bandwidth part for the UE and according to one or more measurement gap configurations, the UE capability corresponding to the reference signal measurements associated with one or more beam mobility or tracking procedures, transmit, based on the UE capability, signaling identifying a first measurement gap configuration defining a first pattern of measurement occasions for reference signal measurements associated with the one or more beam mobility or tracking procedures, and communicate with the UE based on the first measurement gap configuration.

Another apparatus for wireless communication at a network entity is described. The apparatus may include means for receiving an indication of a UE capability of performing reference signal measurements outside an active bandwidth part for the UE and according to one or more measurement gap configurations, the UE capability corresponding to the reference signal measurements associated with one or more beam mobility or tracking procedures, means for transmitting, based on the UE capability, signaling identifying a first measurement gap configuration defining a first pattern of measurement occasions for reference signal measurements associated with the one or more beam mobility or tracking procedures, and means for communicating with the UE based on the first measurement gap configuration.

A non-transitory computer-readable medium storing code for wireless communication at a network entity is described. The code may include instructions executable by at least one processor to receive an indication of a UE capability of performing reference signal measurements outside an active bandwidth part for the UE and according to one or more measurement gap configurations, the UE capability corresponding to the reference signal measurements associated with one or more beam mobility or tracking procedures, transmit, based on the UE capability, signaling identifying a first measurement gap configuration defining a first pattern of measurement occasions for reference signal measurements associated with the one or more beam mobility or tracking procedures, and communicate with the UE based on the first measurement gap configuration.

In some examples of the method, apparatuses, and non-transitory computer-readable medium described herein, receiving the indication may include operations, features, means, or instructions for receiving the indication that the UE supports a single measurement gap configuration for reference signal measurements associated with the one or more beam mobility or tracking procedures and reference signal measurements associated with one or more radio resource management procedures.

In some examples of the method, apparatuses, and non-transitory computer-readable medium described herein, the indication specifies that the single measurement gap configuration may be applicable across a set of frequency ranges.

In some examples of the method, apparatuses, and non-transitory computer-readable medium described herein, receiving the indication may include operations, features, means, or instructions for receiving the indication that the UE supports different measurement gap configurations for reference signal measurements associated with the one or more beam mobility or tracking procedures and for reference signal measurements associated with one or more radio resource management procedures.

In some examples of the method, apparatuses, and non-transitory computer-readable medium described herein, the indication specifies that the different measurement gap configurations may be applicable across a set of frequency ranges.

In some examples of the method, apparatuses, and non-transitory computer-readable medium described herein, receiving the indication may include operations, features, means, or instructions for receiving the indication that the UE supports a measurement gap configuration for respective frequency ranges of a set of frequency ranges, where the measurement gap configuration applicable to both reference signal measurements associated with the one or more beam mobility or tracking procedures and reference signal measurements associated with one or more radio resource management procedures in the respective frequency range.

In some examples of the method, apparatuses, and non-transitory computer-readable medium described herein, receiving the indication may include operations, features, means, or instructions for receiving the indication that the UE supports different measurement gap configurations for reference signal measurements associated with the one or more beam mobility or tracking procedures and for reference signal measurements associated with one or more radio resource management procedures and in different frequency ranges of a set of frequency ranges.

Some examples of the method, apparatuses, and non-transitory computer-readable medium described herein may further include operations, features, means, or instructions for transmitting signaling identifying a second measurement gap configuration defining a second pattern of measurement occasions for reference signal measurements outside the active bandwidth part for the UE and associated with one or more radio resource management procedures and communicating with the UE in accordance with the first measurement gap configuration, the second measurement gap configuration, or both, based on a minimum gap separation threshold.

In some examples of the method, apparatuses, and non-transitory computer-readable medium described herein, reference signal measurements may be performed on synchronization signal blocks, channel state information reference signals, or both.

In some examples of the method, apparatuses, and non-transitory computer-readable medium described herein, receiving the UE capability may include operations, features, means, or instructions for receiving the indication that the UE supports measurement gap configurations differently for the one or more beam mobility and tracking procedures and for one or more radio resource management procedures.

### BRIEF DESCRIPTION OF THE DRAWINGS

FIG. 1 illustrates an example of a wireless communications system that supports synchronization signal block measurement gaps in multiple layers in accordance with one or more aspects of the present disclosure.

FIG. 2 illustrates an example of a wireless communications system that supports synchronization signal block measurement gaps in multiple layers in accordance with one or more aspects of the present disclosure.

FIG. 3A and FIG. 3B illustrate examples of patterns that support synchronization signal block measurement gaps in multiple layers in accordance with one or more aspects of the present disclosure.

FIG. 4 illustrates an example of a process flow that supports synchronization signal block measurement gaps in multiple layers in accordance with one or more aspects of the present disclosure.

FIGS. 5 and 6 show block diagrams of devices that support synchronization signal block measurement gaps in multiple layers in accordance with one or more aspects of the present disclosure.

FIG. 7 shows a block diagram of a communications manager that supports synchronization signal block measurement gaps in multiple layers in accordance with one or more aspects of the present disclosure.

FIG. 8 shows a diagram of a system including a device that supports synchronization signal block measurement gaps in multiple layers in accordance with one or more aspects of the present disclosure.

FIGS. 9 and 10 show block diagrams of devices that support synchronization signal block measurement gaps in multiple layers in accordance with one or more aspects of the present disclosure.

FIG. 11 shows a block diagram of a communications manager that supports synchronization signal block measurement gaps in multiple layers in accordance with one or more aspects of the present disclosure.

FIG. 12 shows a diagram of a system including a device that supports synchronization signal block measurement gaps in multiple layers in accordance with one or more aspects of the present disclosure.

FIGS. 13 through 16 show flowcharts illustrating methods that support synchronization signal block measurement gaps in multiple layers in accordance with one or more aspects of the present disclosure.

### DETAILED DESCRIPTION

A user equipment (UE) may be configured to perform synchronization signal block (SSB) and/or channel state information reference signal (CSI-RS) measurements in a serving cell or in neighboring cells for radio resource management (RRM) (e.g., mobility) purposes (which may be referred to as layer 3 (L3) measurements). The L3 measurements may be performed according to a gap pattern configuration, which indicates a measurement gap length and repetition period and defines a pattern of measurement occasions. The UE may also perform measurements for beam mobility and tracking procedures (which may be referred to as layer 1 (L1) measurements). In current implementations, L1 measurements may not be configured according to a measurement gap configuration, and the UE is not required to perform L1 measurements on reference signal resources outside an active bandwidth part (BWP).

Reduced capability (RedCap) UE devices may be an example of devices such as wearables, industrial wireless sensors, cameras, and a low-end smartphones. These devices may operate with reduced complexity by minimizing the maximum device bandwidth (e.g., 20 MHZ). In such devices, SSBs may not be present in an active BWP of the device to reduce complexity. In such cases, a UE may need to be configured to perform reference signal measurements (e.g., L1 and L3 measurement) outside the active BWP for radio resource management and beam mobility and tracking procedures.

Techniques described herein support L1 measurements by a UE, outside the active bandwidth part of the UE, according to a gap configuration. A UE may report a capability of supporting measurements outside the bandwidth part on a per UE, per frequency, and/or per layer (e.g., L1 and L3) basis. The UE may receive control signaling that identifies a first measurement gap configurations for performing L3 measurements and control signaling that identifies a second measurement gap configuration for preforming L1 measurements. In some examples, one or both of the configurations are based on the reported UE capability.

The measurement gap configurations may define respective patterns of measurement occasions for reference signal (e.g., SSB and CSI-RS) measurements outside the active BWP of the UE. For example, the first measurement gap configuration may define a first pattern of reference signal measurement occasions for the L3 measurements (e.g., measurements for RRM procedures). The second measurement gap configuration may define a second pattern of reference signal measurement occasions for the L1 measurements (e.g., measurements for beam mobility and tracking procedures). In some examples, the configurations may define measurement occasions that overlap or are otherwise positioned such that L1 and L3 measurements in the respective occasions may be difficult, as the UE may take time to adjust for a subsequent measurement gap. As such, the UE may apply a minimum gap separation threshold (e.g., a duration) between measurement occasions of a first pattern (e.g., pattern of L3 measurement occasions) and a second pattern (e.g., the pattern of L1 measurement occasions). If the gap between a L3 measurement occasion and a L1 measurement occasion is less than (or equal to) the minimum gap separation threshold, then the UE may select one of the occasions (e.g., an L1 occasion or an L3 occasion) and perform the corresponding reference signal measurements (e.g., L1 measurements or L3 measurements). In some cases, the selection between occasions that do not satisfy the minimum separation threshold may be based on a selection rule, priorities associated with the occasions, communication conditions/scenarios (e.g., L1 beam quality), or a combination thereof. In some cases, the selection rule or aspects thereof may be configured at the UE by the network.

Thus, these techniques support L1 measurements, in addition to L3 measurements, of reference signals outside the active BWP of the UE. As such, the techniques may support improved reliability and efficiency for UEs, such as reduced capacity UEs. These and other techniques are described in further detail with respect to the figures.

Aspects of the disclosure are initially described in the context of wireless communications systems. Aspects of the disclosure are further described with respect to a wireless communications system illustrating reference signal measurements, patterns of measurement occasions, and a process flow diagram. Aspects of the disclosure are further illustrated by and described with reference to apparatus diagrams, system diagrams, and flowcharts that relate to synchronization signal block measurement gaps in multiple layers.

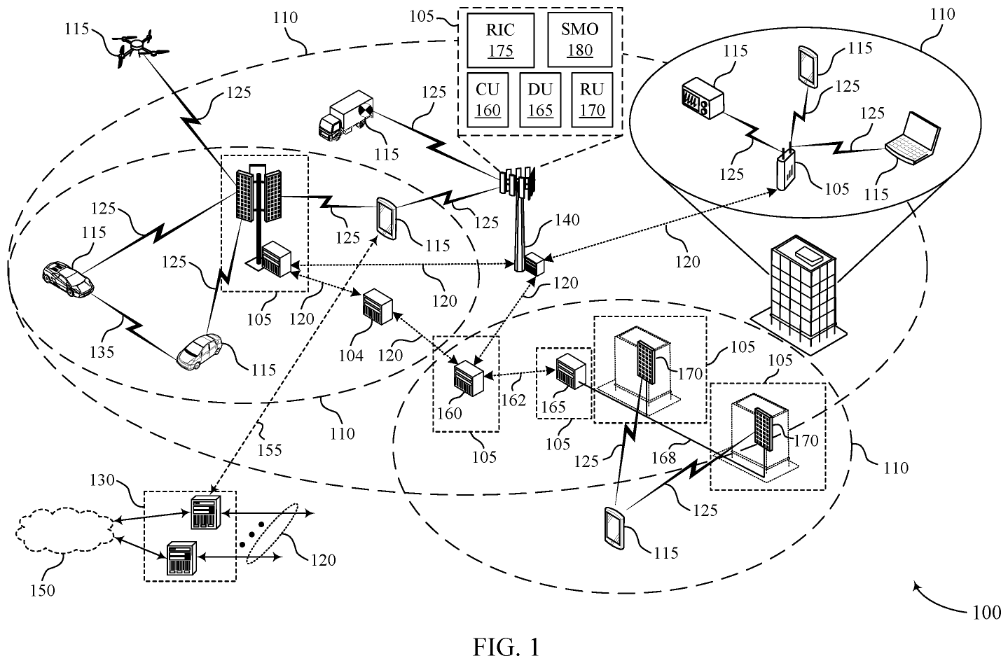

FIG. 1 illustrates an example of a wireless communications system 100 that supports synchronization signal block measurement gaps in multiple layers in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support synchronization signal block measurement gaps in multiple layers as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

As described herein, a UE 115 may utilize a subset of total cell bandwidth of a cell referred to as a BWP. In some UEs 115, the maximum size of a BWP may be reduced to provide power saving and reduced complexity. That is, a first type of UE 115 may be capable of using a BWP of the maximum BWP size, whereas a reduced capacity UE 115 may be a second type of UE that has lower maximum BWP size than the first type of UE for a frequency range. Example reduced capacity UEs 115 may include wearables, industrial wireless sensor networks (IWSN), surveillance cameras, and low-end smartphones. In some cases, data rates for reduced capacity devices may be achieved with BWP sizes less than 100 MHz. In an example implementation, in FR1, a maximum device bandwidth for a UE 115 may be 100 MHz, while the maximum device bandwidth for a reduced capacity UE 115 may be 20 MHz. In FR2, the maximum device bandwidth for a UE 115 may be 200 MHz, while the maximum device bandwidth for a reduced capacity may be 100 MHz. Other maximum device bandwidths may be applicable in other implementations.

Reduced capacity UEs 115 may coexist with other UEs 115 on the same cells. The reduced bandwidth of reduced capacity UEs 115 may, however, may be incompatible with some system configurations. For example, a physical uplink control channel (PUCCH) is typically allocated at the edges of an uplink BWP to allow contiguous physical uplink shared channel (PUSCH) transmissions and random access channel (RACH) transmissions near the center of the uplink BWP. Broadcast signaling for initial access (e.g., channel raster and synchronization signal blocks (SSBs)) are typically transmitted near the middle of the downlink BWP. Accordingly, a reduced capacity UE 115 with a reduced BWP size may not be able to transmit on the PUCCH and receive SSBs or other reference signals. One proposal to accommodate reduced capacity UEs 115 is to provide a separate initial BWP for reduced capacity UEs 115 that carries downlink signaling. The separate initial BWP for reduced capacity UEs 115 may be located near the edge of carrier bandwidth such that the PUCCH resources overlap with the PUCCH resources for other UEs 115. In some proposals, an active BWP may also be configured for reduced capacity UEs 115. Multiple BWPs may provide flexibility for reduced capacity UEs 115, but raise additional issues for signaling and measurements. Broadly, a reduced capacity UE 115 may monitor one BWP at a time, but signaling and reference signals may occur on different BWPs. For example, an active downlink BWP for reduced capacity UEs 115 may not be configured with a SSB or other reference signal for the reduced capacity UEs 115 to use for L1 measurements.

In an aspect, the present disclosure provides for measurement gaps that allow a reduced capacity UE 115 to tune away from an active BWP to an initial BWP (or another BWP) configured with a SSB or CSI-RS for L1 measurements. The reduced capacity UE 115 may receive cell-defining SSBs (CD-SSBs) on a shared initial BWP that is applicable to both reduced capacity UEs 115 and non-reduced-capacity UEs 115. CD-SSBs refer to the set of SSBs that are located at synchronization raster points. Hence, CD-SSBs can be detected by UEs 115 that are performing initial access. The reduced capacity UE 115 may receive non-CD SSBs on a separate initial BWP for reduced capacity UEs 115. Non-CD-SSBs are not located at raster point, and the UE 115 knows the location of the Non-CD-SSBs after being connected to the network (e.g., the shared initial BWP). Both the shared initial BWP and the separate initial BWP may be referred to as an initial BWP. Additionally, CD-SSBs and non-CD-SSBs may be generically referred to as SSBs. The reduced capacity UE 115 may additionally be configured with an active BWP that may not be configured with an SSB (or CSI-RS). Accordingly, the reduced capacity UE may not be able to perform L1 measurements on the active BWP.

As described herein, the reduced capacity UE 115 may be configured with a L1 measurement gap for performing L1 measurements on an initial BWP (or other BWP) configured with a SSB and/or a CSI-RS. The reduced capacity UE 115 may be configured with L1 measurement resources (e.g., specific SSBs identified by an SSB index or CSI-RS resources). The reduced capacity UE 115 may tune away from the active BWP to the initial BWP to perform L1 measurements on the SSBs, the CSI-RSs, or both. For example, the reduced capacity UE 115 may measure one or both of the CD-SSBs on the shared initial downlink BWP and the non-CD-SSBs on the separate initial downlink BWP. The reduced capacity UE 115 may tune back to the active BWP during the L1 measurement gap. Additionally, the configuration of the active BWP may indicate a measurement resource (e.g., for L3 measurements) on any of the shared initial BWP, the separate initial BWP, the active BWP, another BWP, and measurement gaps on the active BWP. The L1 measurement gap may have a shorter measurement gap length (MGL) and/or shorter measurement gap repetition period (MGRP) than L3 measurement gaps. In some cases, the L1 measurement gaps may overlap with the L3 measurement gaps. The reduced capacity UE 115 may perform L1 and L3 measurements concurrently for intra-frequency measurements, or utilize measurement gap sharing with a multi-level sharing factor for inter-frequency and inter-Radio Access Technology (RAT) measurements. Accordingly, a reduced capacity UE 115 may perform L1 measurements despite a lack of an SSB or a CSI-RS transmitted on an active BWP configured for the reduced capacity UE 115.

According to techniques described herein, the reduced capacity UE 115 may indicate a capability of supporting L1 reference signal (SSB and CSI-RS) measurements according to measurement gap configurations. These capabilities may indicate whether the UE 115 is capable of supporting measurement gap configurations (e.g., MGRP and MGL configurations) across a set of frequencies as well as whether these capabilities are applicable to L3 measurements in addition to the L1 measurements. More particularly, the UE may report SSB measurement capability on a per UE, per frequency and/or per layer basis. As such, a UE 115 may be configured with one measurement gap configuration across frequency ranges and layers (e.g., L1 and L3) to make measurements. Additionally, or alternatively, the UE may be configured with one measurement gap configuration across frequency ranges for each layer (e.g., separately for L1 and L3) to make measurements. Additionally, or alternatively, the UE 115 may be configured with one measurement gap configuration across layers for each frequency ranges to make measurements. Additionally, or alternatively, the UE 115 may be configured with different measurement gap configurations for each layer and frequency range to make measurements. As such, the UE 115 may indicate support of different gap patterns for L1 and L3 measurements. If a UE 115 supports “per frequency (per UE) per layer” measurements, the UE 115 supports periodicity and durations of gaps that are different between different layers and frequencies.

Further, as described herein, a L1 measurement occasion may overlap with or with or otherwise may be positioned relative to an L1 measurement occasion such that the UE 115 is not able to perform the respective measurements in the respective occasions. To identify that the occasions are positioned in such a manner, the UE 115 may apply a minimum gap separation threshold between L1 occasions and L3 occasions. More particularly, the UE may determine whether a time separation between an L1 measurement occasion and a L3 measurement occasion is less than the minimum gap separation threshold. If the time separation is less than the minimum gap separation threshold, the UE may identify a collision between the occasions and may select one of the occasions for performing the respective reference signal measurements (e.g., L1 measurements during an L1 measurement occasion or L3 measurement during an L3 measurement occasion).

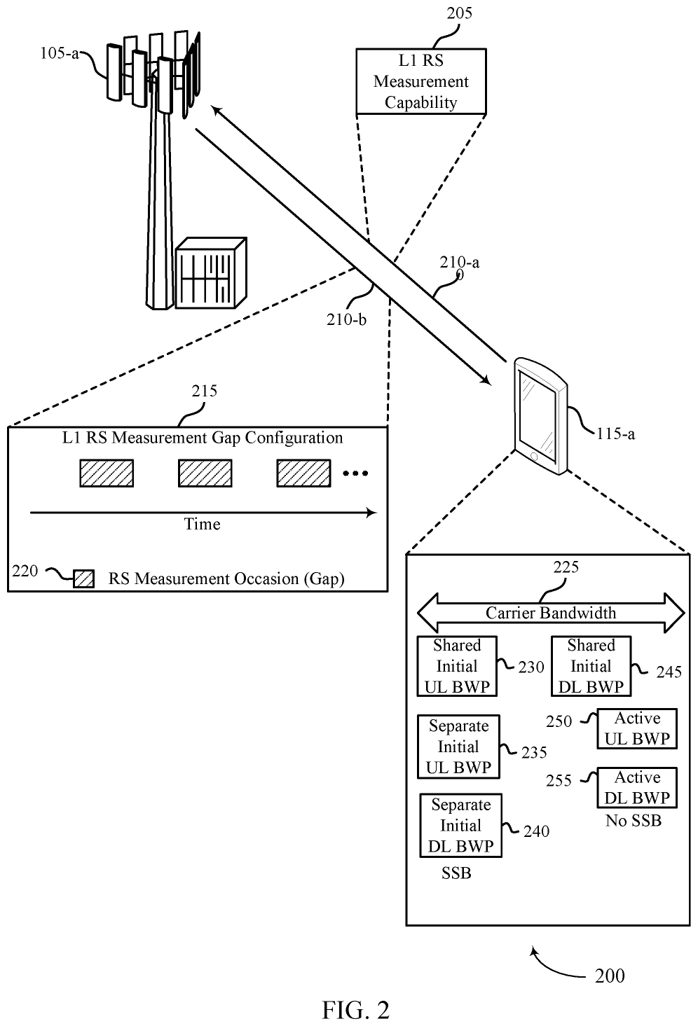

FIG. 2 illustrates an example of a wireless communications system 200 that supports synchronization signal block measurement gaps in multiple layers in accordance with one or more aspects of the present disclosure. The wireless communications system 200 includes a network entity 105-a and a UE 115-a, which may be examples of the corresponding devices described with respect to FIG. 1. The UE 115-a may be an example of a reduced capacity UE as described herein.

The UE 115-a may be configured with multiple BWPs on a carrier bandwidth 225. The carrier bandwidth 225 may be, for example, a maximum system bandwidth. In 5G NR frequency range 1 (FR1), the maximum system bandwidth may be 100 MHz. A cell may be configured with a shared initial BWP 245 (e.g., shared initial uplink BWP) and a shared initial DL BWP 245. The shared initial UL BWP 230 and the shared initial DL BWP 245 may be used by various UEs 115, such as reduced capacity and non-reduced-capacity UEs 115. A non-reduced-capacity UE 115 (or baseline device or legacy device) may refer to a first type of UE 115 capable of using a BWP of a maximum BWP size, whereas a reduced capacity UE 115 may refer a second type of UE that has or has the capability to use or support a lower maximum BWP size than the first type of UE 115 for a frequency range.

The differences between a non-reduced-capacity UE 115 and the reduced capacity UE may result in different usage of the shared initial UL BWP 230 and the shared initial DL BWP 245. In particular, the non-reduced-capacity UEs 115 may continue to use the shared initial UL BWP 230 and the shared initial DL BWP 245 as the initial BWPs after cell acquisition. For example, a maximum BWP size for the non-reduced-capacity UEs 115 may be greater than or equal to the sizes of the shared initial UL BWP 230 and the shared initial DL BWP 245. In contrast, the maximum BWP size for the reduced capacity UEs 115 may be less than the size of the shared initial UL BWP 230 and/or the size of the shared initial DL BWP 245. In some aspects, the reduced capacity UEs 115 may be unable to communicate on a portion of the shared initial UL BWP 230 and/or the shared initial DL BWP 245. For example, the shared initial UL BWP 230 may include a PUCCH resource configured at the edges of the carrier bandwidth 225 and the shared initial DL BWP 245 may carry CD-SSBs near a center of the carrier bandwidth 225. The CD-SSBs may be transmitted according to a channel raster such that the shared initial DL BWP 245 may be located during a cell search. As such, the CD-SSBs define the cell. In an aspect, the reduced capacity UEs 115 may receive a portion of the shared initial DL BWP 245 carrying the CD-SSBs (e.g., an initial control resource set (CORESET)), but may not be able to transmit on the PUCCH resource of the shared initial UL BWP 230.

In an aspect, the CD-SSBs include or identify system information for a separate initial DL BWP 240 for reduced capacity UEs 115. The separate initial DL BWP 240 may carry non-CD-SSBs. The non-CD-SSBs may carry some or all of the information for the cell and information for the separate initial DL BWP 240. The non-CD-SSBs may include information for a separate UL BWP 235 for reduced capacity UEs 115. The separate UL BWP 235 may be located at an edge of the carrier bandwidth 225 and include a PUCCH resource that overlaps with a PUCCH resource of the shared initial UL BWP 230. The UE 115-a may connect to the cell via the separate initial DL BWP 240 and the separate initial UL BWP 235. For example, the UE 115-a may receive the non-CD-SSBs of the separate initial DL BWP 240 to obtain system information and perform measurements. The UE 115-a may perform a random access procedure on the separate initial UL BWP 235. For example, the separate initial UL BWP 235 may include physical random access channel (PRACH) occasions for transmitting an initial random access message. The separate initial DL BWP 240 may include a common search space for receiving a subsequent random access message.

Once the UE 115-a has accessed the cell, the network may configure the UE 115-a with an active UL BWP 250 and an active DL BWP 255. The active DL BWP 255 may be outside of the shared initial DL BWP 245 and/or the separate initial DL BWP 240. In an aspect, the active DL BWP 255 may be configured with signaling to facilitate operation of the UE 115-a. For example, the active DL BWP 255 may carry periodic reference signals such as a tracking reference signal (TRS), channel state information reference signal (CSI-RS), and/or positioning reference signal (PRS). The active DL BWP 255 may include a common search space (CSS) for paging and wake-up signal (WUS). The active DL BWP 255 may include dedicated RRC signaling for system information updates if a paging search space is not configured.

UEs 115-a may perform SSB based L3 measurements (e.g., SSB measurements for RRM procedures), such as RSRP, RSRW, and SINR measurements. The UE 115-a may be configured with measurement gap configurations to identify and measure (L3 measurements) intra-frequency and/or inter-frequency cells. The network (e.g., the network entity 105-b) may configure the UE 115-a with a single UE specific measurement gap pattern or per-frequency measurement gap patterns, depending on the UE capability. Each measurement gap configuration may be associated with a gap pattern identifier that corresponds to a MGL and MGRP, which may define a pattern of measurement occasions for SSB measurements.

UEs 115 may also perform reference signal (e.g., SSB and CSI-RS) based L1 measurements (e.g., reference signal measurements for beam mobility or tracking procedures), which may include radio link monitoring (RLM), beam failure detection (BFD), candidate beam detection (CBD), or L1-RSRP. However, a UE 115 may not be required to perform L1 measurements on SSB resources outside an active BWP, and UEs 115 may be capable of measuring SSBs without measurement gaps for L1 measurements. However, as described herein, L1 measurements outside the active bandwidth part may be useful in some scenarios. For example, these types of measurements may support improved communication reliability and throughput for reduced capacity UEs 115, when an active BWP may not include an SSB for L1 measurements.

As described herein, the active DL BWP 255 may include L3 intra-frequency measurement gaps for measuring neighbor cells and/or reference signals on other BWPs (e.g., the shared initial DL BWP 245 and/or the separate initial DL BWP 240). In an aspect, the active DL BWP 255 may be configured with a separate L1 measurement gap configuration. The L1 measurement gap configuration may have a shorter MGL or MGRP than the L3 measurement gaps. For example, the UE 115-a may measure a single instance of an SSB per measurement resource during each L1 measurement gap. The shorter MGRP may allow the UE 115-a to perform L1 measurements more frequently.

In some examples, to support the L3 and L1 measurement gap configuration for the active DL BWP 255, the UE 115-a may report a UE capability 205 (e.g., a L1 reference signal measurement capability) to the network (e.g., the network entity 105-a). The UE capability 205 may be indicated via control signaling 210-a (e.g., RRC capability signaling). The UE capability 205 may indicate the ability of the UE 115-a to perform the L1 measurements outside the active BWP (e.g., the active DL BWP 255). In some examples, the capability may be indicated on a per UE basis, meaning that the UE 115-a supports one measurement gap configuration across frequency ranges and layers (L1 and L3) to perform reference signal measurements. Additionally, or alternatively, the UE capability 205 may indicate that the UE 115-a may be configured per UE per layer, meaning that the UE 115 supports one measurement gap configuration across frequency ranges for each layer (L1 and L3) to perform reference signal measurements. Additionally, or alternatively, the UE capability 205 may indicate that the UE 115-a may be configured on a per frequency range basis, meaning that the UE 115-a supports one measurement gap configuration across layers (L1 and L3) for each frequency range to perform reference signal measurements. Additionally, or alternatively, the UE capability 205 may indicate that the UE 115-a may be configured with measurement gap configurations on a per frequency range per layer basis, meaning that the UE 115-a supports different measurement gap configurations for each layer (L1 and L3) and frequency range to perform reference signal measurements.

One or more of the described capability indications may be signaled using various techniques. For example, an L1 reference signal measurement configuration field in the signaling 210-a (e.g., field in RRC signaling) may include one or more bits that indicate one of the capabilities. Thus, each bit value of a set of bit values may be mapped to one of the capabilities. In some examples, the UE 115-a may indicate the support of various gap pattern configurations for L1 and/or L3 reference signal measurements via the UE capability 205. For example, the UE 115-a may indicate support of one or more of a set of gap pattern identifiers (corresponding to respective gap pattern configurations) for L1 measurements, L3 measurements, or both. If the UE 115-a indicates support of different measurement gap patterns for L1 and L3 measurements, then UE 115-a may be configured with different measurement gap configurations between different layers (L1 and L3) and frequencies.

The UE 115-a may receive signaling 210-b that identifies a measurement gap configuration 215. The signaling 210-b may be examples of RRC, MAC-CE, DCI, system information signaling, or any combination thereof. The L1 measurement gap configuration 215 may be based on the UE capability 205, and may define a pattern of measurement occasions 220 (gaps) for reference signal (SSB and/or CSI-RS) measurements outside the active bandwidth part (e.g., outside the active DL BWP 255). The pattern of measurement occasions 220 may be defined by a MGR and MGRP indicated via the signaling 210-b. For example, the MGR and MGRP may be mapped to a gap pattern identifier indicated by the signaling 210-b. According to the measurement gap configuration 215, the UE 115-a may switch from the active bandwidth part (e.g., the active DL BWP 255) to a BWP outside the active BWP, such as the shared initial DL BWP 245, the separate initial DL BWP 240, or another BWP, to perform reference signal measurements during the measurement occasions 220.

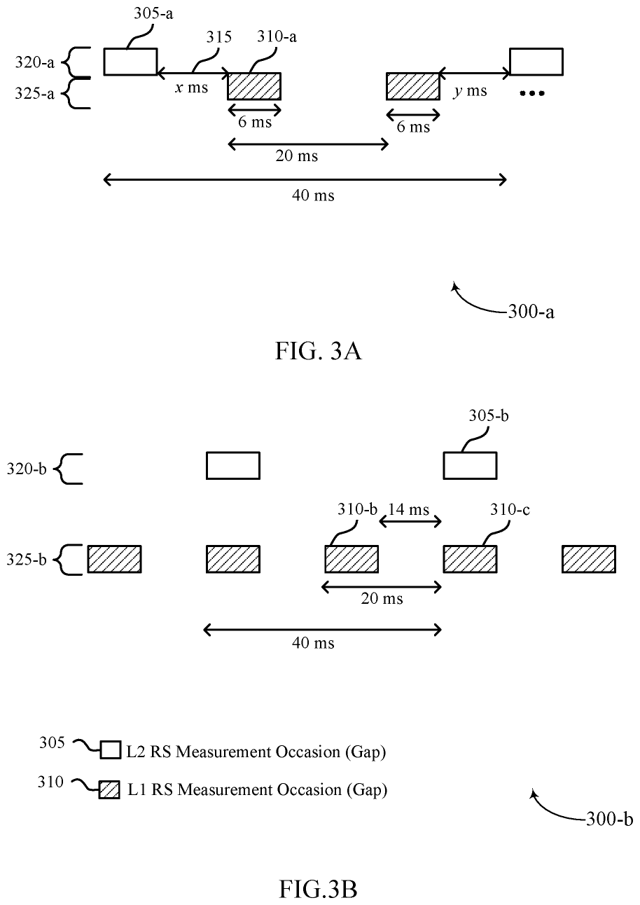

Thus, the UE 115-a may be configured with a gap pattern configuration that defines the pattern of measurement occasions 220 based on capability indications. The UE 115-a may perform L1 measurements (e.g., measurements for beam mobility and tracking procedures) during the measurement occasions 220. As described herein, the UE 115-a may also be configured with a gap pattern configuration that defines a pattern of reference signal measurement occasions for L3 reference signal measurements (e.g., measurements for RRM procedures). In such cases, an L1 measurement occasion and a L3 measurement occasion may be positioned such that the UE 115-a may not be able to perform the respective measurements in each occasion. In such cases, the UE 115-a may select one of the measurement occasions and perform the respective measurements in the selected measurement occasion. This technique is described in further detail with respect to FIG. 3A and FIG. 3B.

FIG. 3A and FIG. 3B illustrate examples of patterns 300 of measurement occasions for reference signal measurements that support synchronization signal block measurement gaps in multiple layers in accordance with one or more aspects of the present disclosure. For example, a UE 115, as described with respect to FIGS. 1 and 2, may be configured with a measurement gap configuration for L1 measurements and a measurement gap configuration for L3 measurements. The measurement gap configurations may define the patterns 300. In some examples, one or more of the measurement gap configurations defining the patterns 300 may be indicated to the UE 115 (e.g., via signaling) in response to the UE indicating a UE capability (e.g., a UE capability 205 of FIG. 2) of performing reference signal measurements outside an active bandwidth part of the UE 115. A UE may receive signaling (e.g., RRC, DCI, MAC-CE, system information) that identifies a first measurement gap configuration defining a first pattern 320-a of measurement occasions 305 for reference signal measurements outside an active BWP for the UE 115 and associated with one or more radio resource management procedures (e.g., L3 measurements). The UE may also receive signaling that identifies a second measurement gap configuration defining a second pattern 325-a of measurement occasions 310 for reference signal measurements outside the active bandwidth part for the UE 115 and associated with one or more beam mobility or tracking procedures (e.g., L1 measurements).

In patterns 300-a of FIG. 3A, the L3 measurement occasions 305 of first pattern 320-a have a gap periodicity of 40 ms, and the reference signal (e.g., SSB or CSI-RS) periodicity may be 20 ms. The measurement occasion length of the L3 measurement occasions 305 (e.g., measurement occasion 305-a) may be 6 ms. As such, the UE 115-a may be configured to measure one of every two reference signal transmissions. The L1 gap periodicity may be 20 ms, and the L1 measurement occasion 310 length may be 6 ms.

In some cases, a measurement occasion 305 and a measurement occasion 310 may be positioned in such a manner such that the UE 115 may not be able to perform measurements in both occasions. For example, the measurement occasion 305-a and the measurement occasion 305-b may be positioned with low time separation such that the UE 115 may not be able to support both measurements due to complexity limitations (e.g., when the UE 115 is a reduced capacity scenario). More particularly, after returning from a measurement occasion, the UE 115 may need a minimum time to prepare for a next measurement occasion, and when two occasions are positioned too close, the UE 115 may not have the time to prepare. To determine a measurement occasion 305 and a measurement occasion 310 collide or conflict, the UE 115 may apply a minimum gap separation threshold 315 between the occasions. If the separation between the occasions if less than the minimum gap separation threshold 315, then the UE 115 may select one of the occasions to perform the respective measurement. The selection may be based on one or more criteria. For example, the UE 115 determines that the time separation between measurement occasion 305-a and measurement occasion 310-a is less than the minimum gap separation threshold 315, then the UE may select either the measurement occasion 305-a or the measurement occasion 310-a for performing the respective reference signal measurements (e.g., L1 measurements or L3 measurements).

The minimum gap separation threshold 315 may depend on a combination of the UE capability, the frequency range, tone spacing, and supported or configured measurement occasion (gap) patterns. In some examples, the minimum gap separation threshold 315 may be defined as: min(L1 gap periodicity, L3 gap periodicity)/2-max(L1 gap length, L3 gap length). The L1/L3 gap periodicities/lengths depend on UE capability and network configurations, as described herein. As such, the minimum gap separation threshold 315 may be determined by the UE based on the configurations or signaled from the network (e.g., network entity 105). In FIG. 3A, the minimum gap separation threshold 315 may be identified based on the L1 and L3 measurement occasion periodicities being greater than or equal to 40 ms and the reference signal periodicity being less than or equal to 20 ms.

Thus, the UE 115 may identify whether the time separation between respective measurement occasions of respective patterns are less than the minimum gap separation threshold 315, and identify a set of reference signal measurement occasions for performing reference signal measurements outside an active bandwidth part. As such, the identified set of measurement occasions may include one or more measurement occasions 305 of the first pattern of measurement occasions 310-a and/or one or more measurement occasions 310 of the second pattern 325-a.

In some cases, the UE 115-a may apply a selection rule when the time separation between occasions is less than the minimum gap separation threshold 315 (e.g., the occasions conflict or collide). The selection rule may be indicated to or configured at the UE 115. For example, if the UE determines that measurement occasion 305-a and the measurement occasion 310-a collide, the UE 115 may select either the measurement occasion 305-a or the measurement occasion 305-b based on a prioritization rule. More particularly, the UE 115 may prioritize L1 measurements over L3 measurements or L3 measurements over L1 measurements. The priorities may be signaled by the network (e.g., by a network entity 105) or configured at the UE 115. Additionally, or alternatively, the UE 115 may prioritize the measurement occasions based on the L1 beam quality of the serving beam and/or the L3 beam quality of the non-serving beams of the serving cell. For example, if the L1 beam quality of the serving beam is relatively low, but the L3 beam quality of the non-serving beam is relatively high, then the UE 115-a may determine to use more frequent L1 measurements and thus select a measurement occasion 310 over a measurement occasion 305. Additionally, or alternatively, the UE 115 may use the mobility of the UE or the channel condition (e.g., SNR) for selection of a measurement occasion.

In patterns 300-b of FIG. 3B, the L3 measurement occasions 310 of pattern 320-b have a gap periodicity of 40 ms, and the reference signal (e.g., SSB or CSI-RS) periodicity may be 20 ms. The measurement occasion (gap) length of the L3 measurement occasions 305 (e.g., measurement occasion 305-b) may be 6 ms. As such, the UE 115-a may be configured to measure one of every two reference signal transmissions. In the second pattern 325-b, the L1 gap periodicity may be 40 ms, and the L1 measurement occasion 310 length may be 6 ms. In the configuration of FIG. 3B, the shortest time separation (e.g., the minimum gap separation threshold 315) may be 14 ms, as 14 ms=min(L1 gap periodicity, L3 gap periodicity)/2−max(L1 gap length, L3 gap length)=min(40, 40)/2−max(6, 6) ms.

In FIG. 3B, the UE 115 may select either the measurement occasion 310-b or the measurement occasion 305-b, if the time serration between the occasions is less than 14 ms (e.g., a minimum gap separation threshold). The selection may be based on various criteria, as described herein. Additionally, the UE 115 may select either the measurement occasion 305-b or the measurement occasion 310-c, as these measurement occasions overlap or collide (e.g., a time separation is less than the minimum gap separation threshold).

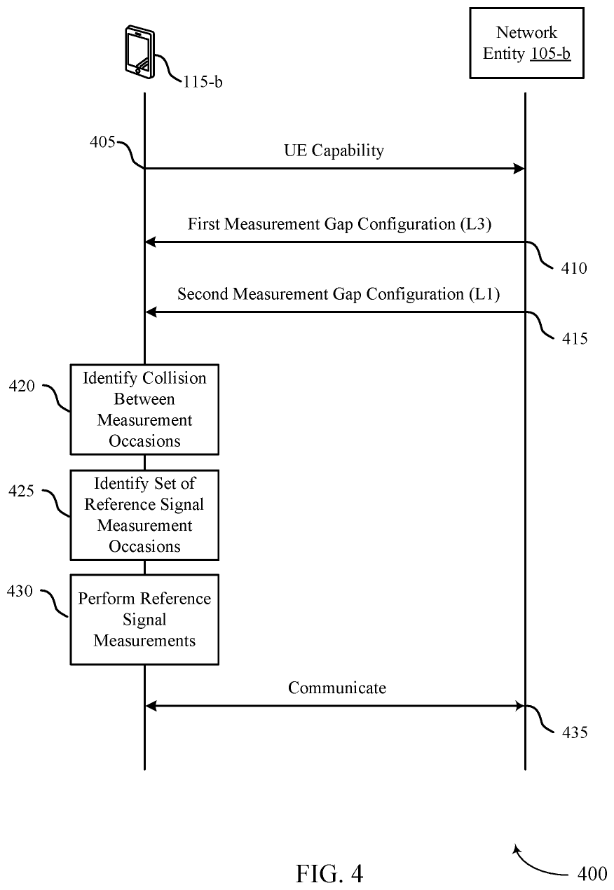

FIG. 4 illustrates an example of a process flow 400 that supports synchronization signal block measurement gaps in multiple layers in accordance with one or more aspects of the present disclosure. The process flow 400 includes a UE 115-b and a network entity 105-b, which may be examples of the corresponding devices as described with respect to FIGS. 1 through 3A and 3B. In some examples, the UE 115 is a reduced capacity UE.

In the following description of the process flow 400, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 400, and other operations may be added to the process flow 400.

At 405, the UE 115-b may transmit an indication of a UE capability of performing reference signal measurements outside an active bandwidth part for the UE 115-b and according to one or more measurement gap configurations. The UE capability may correspond to the reference signal measurements associated with one or more beam mobility or tracking procedures (e.g., L1 measurement capabilities). In some cases, the indication may specify whether the UE supports a single measurement gap configuration for reference signal measurements associated with the one or more beam mobility or tracking procedures and reference signal measurements associated with one or more radio resource management procedures (e.g., L3 measurements). The indication may specify that a single measurement gap configuration is applicable across a set of frequency ranges. The capability may also indicate that the UE supports different measurement gap configurations for reference signal measurements associated with the one or more beam mobility or tracking procedures and for reference signal measurements associated with one or more radio resource management procedures. Additionally, or alternatively, the indication may specify that the UE supports a measurement gap configuration for respective frequency ranges of a set of frequency ranges, where the measurement gap configuration applicable to both reference signal measurements associated with the one or more beam mobility or tracking procedures and reference signal measurements associated with one or more radio resource management procedures in the respective frequency range.

Additionally, or alternatively, the capability indication may specify that the UE supports different measurement gap configurations for reference signal measurements associated with the one or more beam mobility or tracking procedures and for reference signal measurements associated with one or more radio resource management procedures and in different frequency ranges of a set of frequency ranges. In some cases, the capability indication may specify that the UE supports measurement gap configurations differently for the one or more beam mobility and tracking procedures and for one or more radio resource management procedures.

At 410, the UE 115-b may receive signaling identifying a first measurement gap configuration defining a first pattern of measurement occasions for reference signal measurements outside an active bandwidth part for the UE and associated with one or more radio resource management procedures (e.g., L3 measurements). The first measurement gap configuration may be indicated based on the UE capability indication.

At 415, the UE 115-b may receive signaling identifying a second measurement gap configuration defining a second pattern of measurement occasions for reference signal measurements outside the active bandwidth part for the UE and associated with one or more beam mobility or tracking procedures (e.g., L1 measurements). The second measurement gap may be indicated based on the UE capability indication.

At 420, the UE 115-b may identify a collision between a reference signal measurement occasion of the first pattern and a reference signal measurement occasion of the second pattern. The collision may be identified based on a time separation between the measurement occasion of the first pattern and the measurement occasion of the second pattern being less than a minimum gap separation threshold. The minimum gap separation threshold may be identified by the UE 115-b and/or configured at the UE 115-b based on the configured patterns, the UE capability, a tone spacing, a frequency, or a combination thereof. In some examples, the minimum gap separation threshold is based on a measurement occasion periodicity of the first pattern, a measurement occasion periodicity of the second pattern, a measurement occasion length of the first pattern, a measurement occasion length of the second pattern, or a combination thereof.

At 425, the UE 115-b may identify a set of reference signal measurement occasions based at least in part on the first pattern of measurement occasions, the second pattern of measurement occasions, and the minimum gap separation threshold applicable between measurement occasions of the first pattern and measurement occasions of the second pattern. For example, upon identification of a collision between measurement occasions of the first pattern and the second pattern, the UE 115-b may select one of the occasions for measurement. The selection may be based on an selection rule, which may consider respective priorities associated with the measurement occasions, a beam quality of a serving beam, a beam quality of a non-serving beam, a mobility of the UE, channel conditions, or a combination thereof. The beam quality of the serving beam, the beam quality of the non-serving beam, or both may be based on one or more combinations of signal-to-noise ratio (SNR), reference signal receive power (RSRP), reference signal received quality (RSRQ), layer one reference signal receive power (L1-RSRP), or a combination thereof. Thus, the UE 115-b may identify the set of reference signal measurement occasions from the first pattern and/or the second pattern and select between occasions that have a time separation that is less than the minimum gap separation threshold.

At 430, the UE 115-b may perform the reference signal measurements during the set of reference signal measurement occasions that is identified based at least in part on the first pattern of measurement occasions, the second pattern of measurement occasions, and the minimum gap separation threshold applicable between measurement occasions of the first pattern and measurement occasions of the second pattern. In some examples, the UE 115-b may report the measurements or perform procedures (e.g., radio resource management procedures and/or beam mobility or management procedures) based on the reference signal measurements. The reference signals may be SSBs, CSI-RSs, or both.

At 435, the UE 115-b and the network entity 105-b may communicate based on the first measurement gap configuration, the second measurement gap configuration, the minimum gap separation threshold, the measurements performed by the UE 115-b, or any combination thereof.

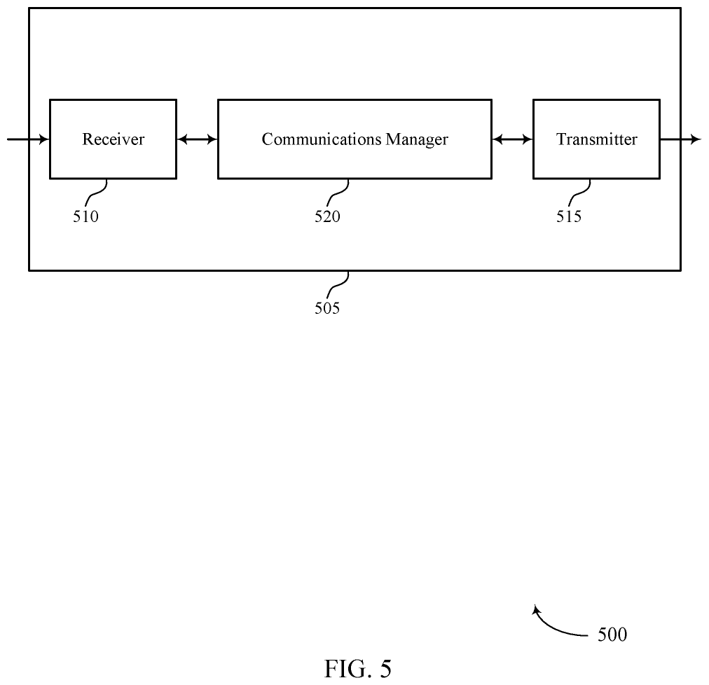

FIG. 5 shows a block diagram 500 of a device 505 that supports synchronization signal block measurement gaps in multiple layers in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to synchronization signal block measurement gaps in multiple layers). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to synchronization signal block measurement gaps in multiple layers). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of synchronization signal block measurement gaps in multiple layers as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in software or code executed by a processor. If implemented in software or code executed by a processor, the functions of the communications manager 520, the receiver 510, the transmitter 515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving signaling identifying a first measurement gap configuration defining a first pattern of measurement occasions for reference signal measurements outside an active bandwidth part for the UE and associated with one or more radio resource management procedures. The communications manager 520 may be configured as or otherwise support a means for receiving signaling identifying a second measurement gap configuration defining a second pattern of measurement occasions for reference signal measurements outside the active bandwidth part for the UE and associated with one or more beam mobility or tracking procedures. The communications manager 520 may be configured as or otherwise support a means for performing the reference signal measurements during a set of reference signal measurement occasions that is identified based on the first pattern of measurement occasions, the second pattern of measurement occasions, and a minimum gap separation threshold applicable between measurement occasions of the first pattern and measurement occasions of the second pattern.

Additionally, or alternatively, the communications manager 520 may support wireless communication at a UE in accordance with examples as disclosed herein. For example, the communications manager 520 may be configured as or otherwise support a means for transmitting an indication of a UE capability of performing reference signal measurements outside an active bandwidth part for the UE and according to one or more measurement gap configurations, the UE capability corresponding to the reference signal measurements associated with one or more beam mobility or tracking procedures. The communications manager 520 may be configured as or otherwise support a means for receiving, based on transmitting the indication, signaling identifying a first measurement gap configuration defining a first pattern of measurement occasions for reference signal measurements associated with the one or more beam mobility or tracking procedures. The communications manager 520 may be configured as or otherwise support a means for performing the reference signal measurements during a set of reference signal measurement occasions that is identified based on the first measurement gap configuration.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing and reduced power consumption by supporting measurements outside an active bandwidth part. As a result, the communication resources may be efficiently used.

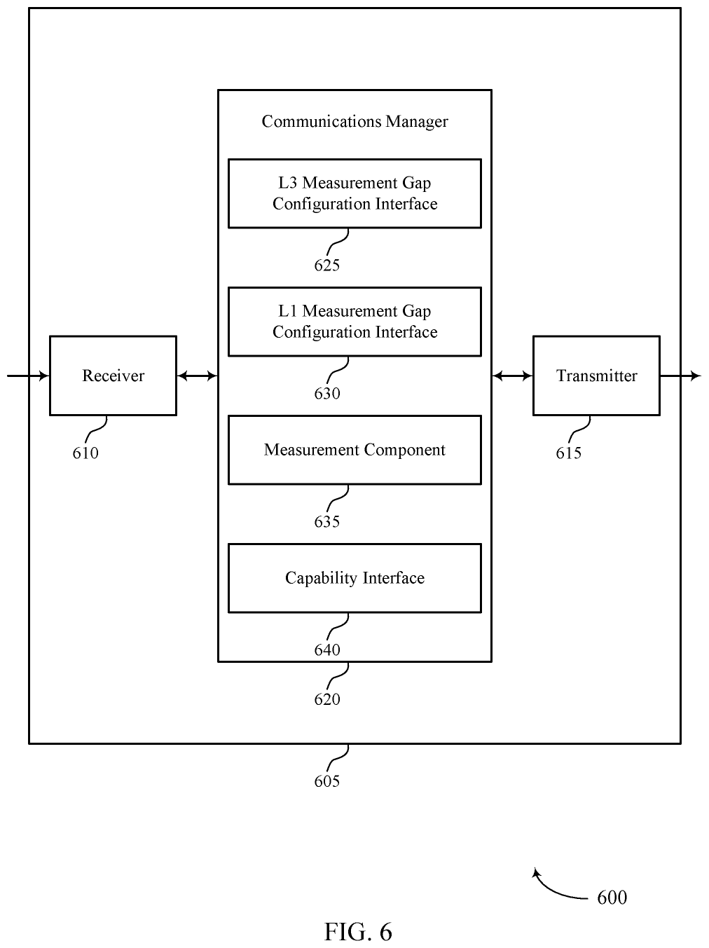

FIG. 6 shows a block diagram 600 of a device 605 that supports synchronization signal block measurement gaps in multiple layers in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to synchronization signal block measurement gaps in multiple layers). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to synchronization signal block measurement gaps in multiple layers). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of synchronization signal block measurement gaps in multiple layers as described herein. For example, the communications manager 620 may include a L3 measurement gap configuration interface 625, a L1 measurement gap configuration interface 630, a measurement component 635, a capability interface 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The L3 measurement gap configuration interface 625 may be configured as or otherwise support a means for receiving signaling identifying a first measurement gap configuration defining a first pattern of measurement occasions for reference signal measurements outside an active bandwidth part for the UE and associated with one or more radio resource management procedures. The L1 measurement gap configuration interface 630 may be configured as or otherwise support a means for receiving signaling identifying a second measurement gap configuration defining a second pattern of measurement occasions for reference signal measurements outside the active bandwidth part for the UE and associated with one or more beam mobility or tracking procedures. The measurement component 635 may be configured as or otherwise support a means for performing the reference signal measurements during a set of reference signal measurement occasions that is identified based on the first pattern of measurement occasions, the second pattern of measurement occasions, and a minimum gap separation threshold applicable between measurement occasions of the first pattern and measurement occasions of the second pattern.

Additionally, or alternatively, the communications manager 620 may support wireless communication at a UE in accordance with examples as disclosed herein. The capability interface 640 may be configured as or otherwise support a means for transmitting an indication of a UE capability of performing reference signal measurements outside an active bandwidth part for the UE and according to one or more measurement gap configurations, the UE capability corresponding to the reference signal measurements associated with one or more beam mobility or tracking procedures. The L1 measurement gap configuration interface 630 may be configured as or otherwise support a means for receiving, based on transmitting the indication, signaling identifying a first measurement gap configuration defining a first pattern of measurement occasions for reference signal measurements associated with the one or more beam mobility or tracking procedures. The measurement component 635 may be configured as or otherwise support a means for performing the reference signal measurements during a set of reference signal measurement occasions that is identified based on the first measurement gap configuration.

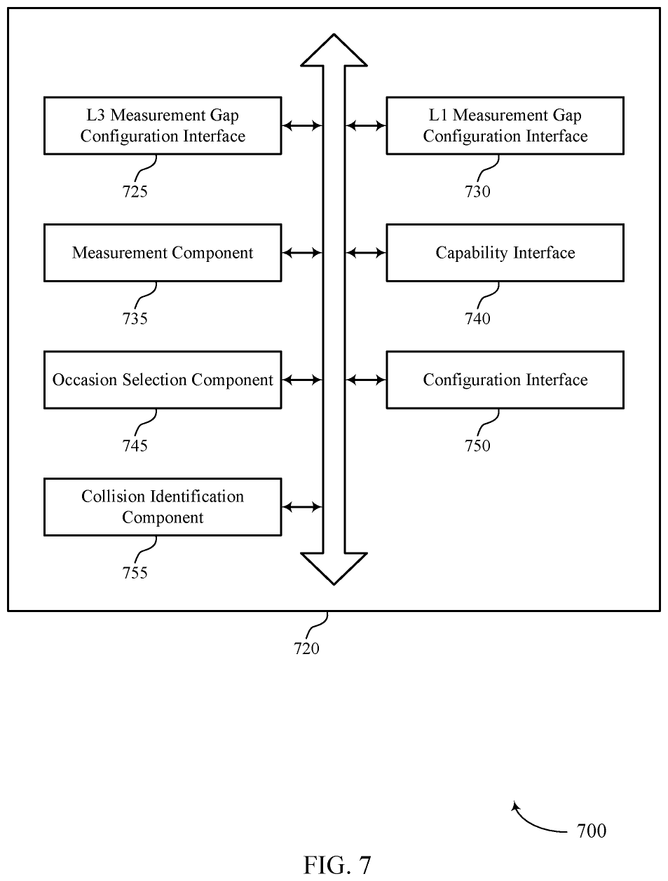

FIG. 7 shows a block diagram 700 of a communications manager 720 that supports synchronization signal block measurement gaps in multiple layers in accordance with one or more aspects of the present disclosure. The communications manager 720 may be an example of aspects of a communications manager 520, a communications manager 620, or both, as described herein. The communications manager 720, or various components thereof, may be an example of means for performing various aspects of synchronization signal block measurement gaps in multiple layers as described herein. For example, the communications manager 720 may include a L3 measurement gap configuration interface 725, a L1 measurement gap configuration interface 730, a measurement component 735, a capability interface 740, an occasion selection component 745, a configuration interface 750, a collision identification component 755, or any combination thereof. Each of these components may communicate, directly or indirectly, with one another (e.g., via one or more buses).

The communications manager 720 may support wireless communication at a UE in accordance with examples as disclosed herein. The L3 measurement gap configuration interface 725 may be configured as or otherwise support a means for receiving signaling identifying a first measurement gap configuration defining a first pattern of measurement occasions for reference signal measurements outside an active bandwidth part for the UE and associated with one or more radio resource management procedures. The L1 measurement gap configuration interface 730 may be configured as or otherwise support a means for receiving signaling identifying a second measurement gap configuration defining a second pattern of measurement occasions for reference signal measurements outside the active bandwidth part for the UE and associated with one or more beam mobility or tracking procedures. The measurement component 735 may be configured as or otherwise support a means for performing the reference signal measurements during a set of reference signal measurement occasions that is identified based on the first pattern of measurement occasions, the second pattern of measurement occasions, and a minimum gap separation threshold applicable between measurement occasions of the first pattern and measurement occasions of the second pattern.

In some examples, the capability interface 740 may be configured as or otherwise support a means for transmitting an indication of a UE capability of performing reference signal measurements outside the active bandwidth part for the UE and according to one or more measurement gap configurations, the UE capability corresponding to the reference signal measurements associated with the one or more beam mobility or tracking procedures, where the signaling identifying the first measurement gap configuration, the signaling identifying the second measurement gap configuration, or both, are received based on transmitting the indication of the UE capability.

In some examples, the measurement component 735 may be configured as or otherwise support a means for performing a reference signal measurement during a first measurement occasion of the first pattern or a second measurement occasion of the second pattern based on a time separation between the first measurement occasion and the second measurement occasion being less than the minimum gap separation threshold.

In some examples, the occasion selection component 745 may be configured as or otherwise support a means for selecting either the first measurement occasion or the second measurement occasion for performing the reference signal measurement in accordance with a selection rule that is applied when the time separation is less than the minimum gap separation threshold.

In some examples, the occasion selection component 745 may be configured as or otherwise support a means for selecting either the first measurement occasion or the second measurement occasion for performing the reference signal measurement in accordance with a first priority associated with the first pattern and a second priority associated with the second pattern.

In some examples, the occasion selection component 745 may be configured as or otherwise support a means for selecting either the first measurement occasion or the second measurement occasion for performing the reference signal measurement based on a beam quality of a serving beam, a beam quality of a non-serving beam, a mobility of the UE, channel conditions, or a combination thereof.

In some examples, the beam quality of the serving beam, the beam quality of the non-serving beam is based at least in part on one or more combinations of signal-to-noise ratio, reference signal receive power (RSRP), reference signal received quality (RSRQ), layer one reference signal receive power (L1-RSRP), or a combination thereof.

In some examples, the collision identification component 755 may be configured as or otherwise support a means for identifying a collision based on the time separation being less than the minimum gap separation threshold, where the reference signal measurement is performed during the first measurement occasion or the second measurement occasion based on identifying the collision.

In some examples, the occasion selection component 745 may be configured as or otherwise support a means for receiving signaling that identifies a selection rule that is used by the UE to select, for performing the reference signal measurements, either a first measurement occasion of the first pattern or a second measurement occasion of the second pattern when a time separation between the first measurement occasion and the second measurement occasion is less than the minimum gap separation threshold.

In some examples, the minimum gap separation threshold is based on a measurement occasion periodicity of the first pattern, a measurement occasion periodicity of the second pattern, a measurement occasion length of the first pattern, a measurement occasion length of the second pattern, or a combination thereof.

In some examples, the minimum gap separation threshold is based on a tone spacing, a frequency, a UE capability, or a combination thereof.

In some examples, the configuration interface 750 may be configured as or otherwise support a means for receiving signaling indicating the minimum gap separation threshold.

In some examples, reference signal measurements are performed on synchronization signal blocks, channel state information reference signals, or both.

Additionally, or alternatively, the communications manager 720 may support wireless communication at a UE in accordance with examples as disclosed herein. The capability interface 740 may be configured as or otherwise support a means for transmitting an indication of a UE capability of performing reference signal measurements outside an active bandwidth part for the UE and according to one or more measurement gap configurations, the UE capability corresponding to the reference signal measurements associated with one or more beam mobility or tracking procedures. In some examples, the L1 measurement gap configuration interface 730 may be configured as or otherwise support a means for receiving, based on transmitting the indication, signaling identifying a first measurement gap configuration defining a first pattern of measurement occasions for reference signal measurements associated with the one or more beam mobility or tracking procedures. In some examples, the measurement component 735 may be configured as or otherwise support a means for performing the reference signal measurements during a set of reference signal measurement occasions that is identified based on the first measurement gap configuration.

In some examples, to support transmitting the UE capability, the capability interface 740 may be configured as or otherwise support a means for transmitting the indication that the UE supports a single measurement gap configuration for reference signal measurements associated with the one or more beam mobility or tracking procedures and reference signal measurements associated with one or more radio resource management procedures.

In some examples, the indication specifies that the single measurement gap configuration is applicable across a set of frequency ranges.

In some examples, to support transmitting the UE capability, the capability interface 740 may be configured as or otherwise support a means for transmitting the indication that the UE supports different measurement gap configurations for reference signal measurements associated with the one or more beam mobility or tracking procedures and for reference signal measurements associated with one or more radio resource management procedures.

In some examples, the indication specifies that the different measurement gap configurations are applicable across a set of frequency ranges.

In some examples, to support transmitting the UE capability, the capability interface 740 may be configured as or otherwise support a means for transmitting the indication that the UE supports a measurement gap configuration for respective frequency ranges of a set of frequency ranges, where the measurement gap configuration applicable to both reference signal measurements associated with the one or more beam mobility or tracking procedures and reference signal measurements associated with one or more radio resource management procedures in the respective frequency range.

In some examples, to support transmitting the UE capability, the capability interface 740 may be configured as or otherwise support a means for transmitting the indication that the UE supports different measurement gap configurations for reference signal measurements associated with the one or more beam mobility or tracking procedures and for reference signal measurements associated with one or more radio resource management procedures and in different frequency ranges of a set of frequency ranges.

In some examples, the L3 measurement gap configuration interface 725 may be configured as or otherwise support a means for receiving signaling identifying a second measurement gap configuration defining a second pattern of measurement occasions for reference signal measurements outside the active bandwidth part for the UE and associated with one or more radio resource management procedures. In some examples, the measurement component 735 may be configured as or otherwise support a means for performing the reference signal measurements during a set of reference signal measurement occasions that is identified based on the first pattern of measurement occasions, the second pattern of measurement occasions, and a minimum gap separation threshold applicable between measurement occasions of the first pattern and measurement occasions of the second pattern.

In some examples, to support transmitting the UE capability, the capability interface 740 may be configured as or otherwise support a means for transmitting the indication that the UE supports measurement gap configurations differently for the one or more beam mobility and tracking procedures and for one or more radio resource management procedures.

In some examples, reference signal measurements are performed on synchronization signal blocks, channel state information reference signals, or both.

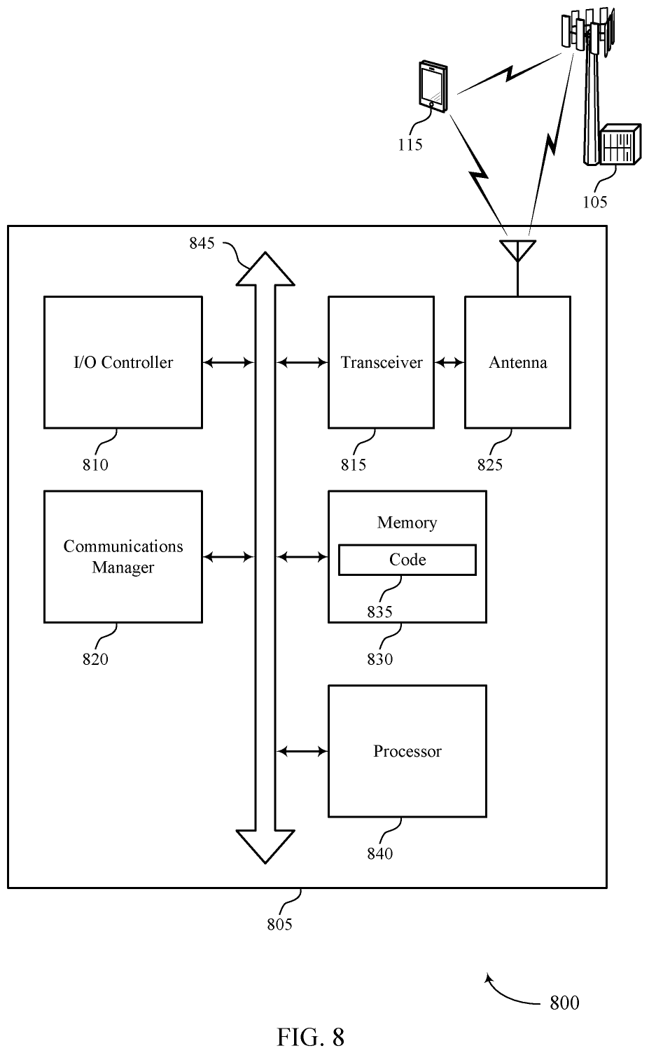

FIG. 8 shows a diagram of a system 800 including a device 805 that supports synchronization signal block measurement gaps in multiple layers in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting synchronization signal block measurement gaps in multiple layers). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving signaling identifying a first measurement gap configuration defining a first pattern of measurement occasions for reference signal measurements outside an active bandwidth part for the UE and associated with one or more radio resource management procedures. The communications manager 820 may be configured as or otherwise support a means for receiving signaling identifying a second measurement gap configuration defining a second pattern of measurement occasions for reference signal measurements outside the active bandwidth part for the UE and associated with one or more beam mobility or tracking procedures. The communications manager 820 may be configured as or otherwise support a means for performing the reference signal measurements during a set of reference signal measurement occasions that is identified based on the first pattern of measurement occasions, the second pattern of measurement occasions, and a minimum gap separation threshold applicable between measurement occasions of the first pattern and measurement occasions of the second pattern.

Additionally, or alternatively, the communications manager 820 may support wireless communication at a UE in accordance with examples as disclosed herein. For example, the communications manager 820 may be configured as or otherwise support a means for transmitting an indication of a UE capability of performing reference signal measurements outside an active bandwidth part for the UE and according to one or more measurement gap configurations, the UE capability corresponding to the reference signal measurements associated with one or more beam mobility or tracking procedures. The communications manager 820 may be configured as or otherwise support a means for receiving, based on transmitting the indication, signaling identifying a first measurement gap configuration defining a first pattern of measurement occasions for reference signal measurements associated with the one or more beam mobility or tracking procedures. The communications manager 820 may be configured as or otherwise support a means for performing the reference signal measurements during a set of reference signal measurement occasions that is identified based on the first measurement gap configuration.

By including or configuring the communications manager 820 in accordance with examples as described herein, the device 805 may support techniques for improved communication reliability by supporting measurements outside an active bandwidth part, which may support identification of beams and/or resources to support communications. As a result, communication resources may be efficiently sued, which may result in reduced latency and longer battery life.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of synchronization signal block measurement gaps in multiple layers as described herein, or the processor 840 and the memory 830 may be otherwise configured to perform or support such operations.

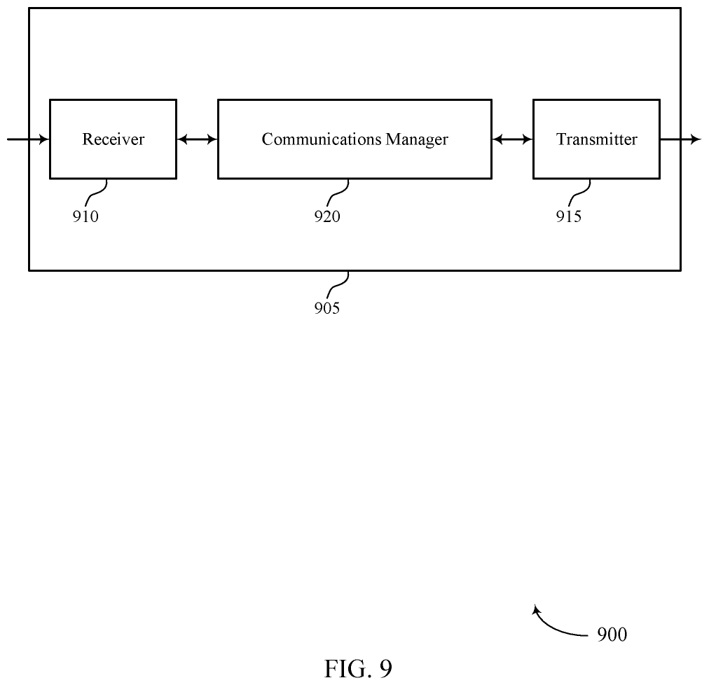

FIG. 9 shows a block diagram 900 of a device 905 that supports synchronization signal block measurement gaps in multiple layers in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of synchronization signal block measurement gaps in multiple layers as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in software or code executed by a processor. If implemented in software or code executed by a processor, the functions of the communications manager 920, the receiver 910, the transmitter 915, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a base station in accordance with examples as disclosed herein. For example, the communications manager 920 may be configured as or otherwise support a means for transmitting signaling identifying a first measurement gap configuration defining a first pattern of measurement occasions for reference signal measurements outside an active bandwidth part for the UE and associated with one or more radio resource management procedures. The communications manager 920 may be configured as or otherwise support a means for transmitting signaling identifying a second measurement gap configuration defining a second pattern of measurement occasions for reference signal measurements outside the active bandwidth part for the UE and associated with one or more beam mobility or tracking procedures. The communications manager 920 may be configured as or otherwise support a means for communicating with the UE in accordance with the first measurement gap configuration, the second measurement gap configuration, or both, based on a minimum gap separation threshold.

Additionally, or alternatively, the communications manager 920 may support wireless communication at a base station in accordance with examples as disclosed herein. For example, the communications manager 920 may be configured as or otherwise support a means for receiving an indication of a UE capability of performing reference signal measurements outside an active bandwidth part for the UE and according to one or more measurement gap configurations, the UE capability corresponding to the reference signal measurements associated with one or more beam mobility or tracking procedures. The communications manager 920 may be configured as or otherwise support a means for transmitting, based on the UE capability, signaling identifying a first measurement gap configuration defining a first pattern of measurement occasions for reference signal measurements associated with the one or more beam mobility or tracking procedures. The communications manager 920 may be configured as or otherwise support a means for communicating with the UE based on the first measurement gap configuration.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing and reduced power consumption by supporting measurements outside an active bandwidth part. As a result, the communication resources may be efficiently used.

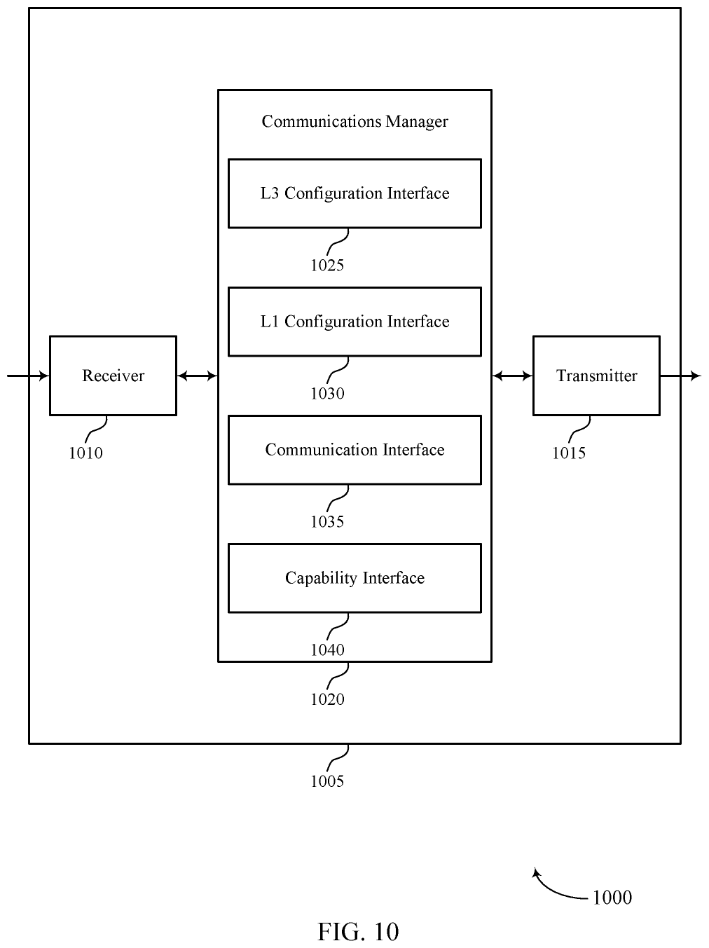

FIG. 10 shows a block diagram 1000 of a device 1005 that supports synchronization signal block measurement gaps in multiple layers in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of synchronization signal block measurement gaps in multiple layers as described herein. For example, the communications manager 1020 may include a L3 configuration interface 1025, a L1 configuration interface 1030, a communication interface 1035, a capability interface 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a base station in accordance with examples as disclosed herein. The L3 configuration interface 1025 may be configured as or otherwise support a means for transmitting signaling identifying a first measurement gap configuration defining a first pattern of measurement occasions for reference signal measurements outside an active bandwidth part for the UE and associated with one or more radio resource management procedures. The L1 configuration interface 1030 may be configured as or otherwise support a means for transmitting signaling identifying a second measurement gap configuration defining a second pattern of measurement occasions for reference signal measurements outside the active bandwidth part for the UE and associated with one or more beam mobility or tracking procedures. The communication interface 1035 may be configured as or otherwise support a means for communicating with the UE in accordance with the first measurement gap configuration, the second measurement gap configuration, or both, based on a minimum gap separation threshold.

Additionally, or alternatively, the communications manager 1020 may support wireless communication at a base station in accordance with examples as disclosed herein. The capability interface 1040 may be configured as or otherwise support a means for receiving an indication of a UE capability of performing reference signal measurements outside an active bandwidth part for the UE and according to one or more measurement gap configurations, the UE capability corresponding to the reference signal measurements associated with one or more beam mobility or tracking procedures. The L1 configuration interface 1030 may be configured as or otherwise support a means for transmitting, based on the UE capability, signaling identifying a first measurement gap configuration defining a first pattern of measurement occasions for reference signal measurements associated with the one or more beam mobility or tracking procedures. The communication interface 1035 may be configured as or otherwise support a means for communicating with the UE based on the first measurement gap configuration.

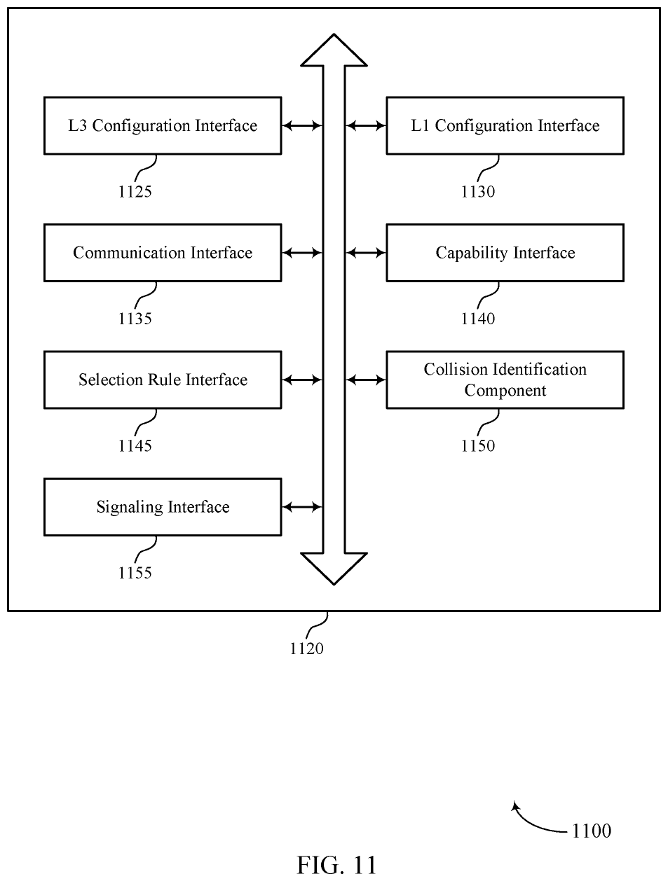

FIG. 11 shows a block diagram 1100 of a communications manager 1120 that supports synchronization signal block measurement gaps in multiple layers in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of synchronization signal block measurement gaps in multiple layers as described herein. For example, the communications manager 1120 may include a L3 configuration interface 1125, a L1 configuration interface 1130, a communication interface 1135, a capability interface 1140, a selection rule interface 1145, a collision identification component 1150, a signaling interface 1155, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a base station in accordance with examples as disclosed herein. The L3 configuration interface 1125 may be configured as or otherwise support a means for transmitting signaling identifying a first measurement gap configuration defining a first pattern of measurement occasions for reference signal measurements outside an active bandwidth part for the UE and associated with one or more radio resource management procedures. The L1 configuration interface 1130 may be configured as or otherwise support a means for transmitting signaling identifying a second measurement gap configuration defining a second pattern of measurement occasions for reference signal measurements outside the active bandwidth part for the UE and associated with one or more beam mobility or tracking procedures. The communication interface 1135 may be configured as or otherwise support a means for communicating with the UE in accordance with the first measurement gap configuration, the second measurement gap configuration, or both, based on a minimum gap separation threshold.

In some examples, the capability interface 1140 may be configured as or otherwise support a means for receiving an indication of a UE capability of performing reference signal measurements outside the active bandwidth part for the UE and according to one or more measurement gap configurations, the UE capability corresponding to the reference signal measurements associated with the one or more beam mobility or tracking procedures, where the signaling identifying the first measurement gap configuration, the signaling identifying the second measurement gap configuration, or both, are transmitted based on transmitting the indication of the UE capability.

In some examples, the selection rule interface 1145 may be configured as or otherwise support a means for transmitting signaling that identifies a selection rule that is used by the UE to select, for performing a reference signal measurement, either a first measurement occasion of the first pattern or a second measurement occasion of the second pattern when a time separation between the first measurement occasion and the second measurement occasion is less than the minimum gap separation threshold.

In some examples, the selection rule specifies that the UE is to use a first priority associated with the first pattern and a second priority associated with the second pattern in selecting between the first measurement occasion and the second measurement occasion for performing the reference signal measurement.

In some examples, the selection rule specifies that the UE is to use a beam quality of a serving beam, a beam quality of a non-serving beam, a mobility of the UE, a channel condition, or a combination thereof, for selecting between the first measurement occasion and the second measurement occasion for performing the reference signal measurement.

In some examples, the collision identification component 1150 may be configured as or otherwise support a means for identifying a collision between a first measurement occasion of the first pattern and a second measurement occasion of the second pattern based on a time separation between the first measurement occasion and the second measurement occasion being less than the minimum gap separation threshold.

In some examples, the minimum gap separation threshold is based on a measurement occasion periodicity of the first pattern, a measurement occasion periodicity of the second pattern, a measurement occasion length of the first pattern, a measurement occasion length of the second pattern, or a combination thereof.

In some examples, the signaling interface 1155 may be configured as or otherwise support a means for transmitting signaling indicating the minimum gap separation threshold.

In some examples, the minimum gap separation threshold is based on a tone spacing, a frequency, a UE capability, or a combination thereof.

In some examples, reference signal measurements are performed on synchronization signal blocks, channel state information reference signals, or both.

Additionally, or alternatively, the communications manager 1120 may support wireless communication at a base station in accordance with examples as disclosed herein. The capability interface 1140 may be configured as or otherwise support a means for receiving an indication of a UE capability of performing reference signal measurements outside an active bandwidth part for the UE and according to one or more measurement gap configurations, the UE capability corresponding to the reference signal measurements associated with one or more beam mobility or tracking procedures. In some examples, the L1 configuration interface 1130 may be configured as or otherwise support a means for transmitting, based on the UE capability, signaling identifying a first measurement gap configuration defining a first pattern of measurement occasions for reference signal measurements associated with the one or more beam mobility or tracking procedures. In some examples, the communication interface 1135 may be configured as or otherwise support a means for communicating with the UE based on the first measurement gap configuration.

In some examples, to support receiving the indication, the capability interface 1140 may be configured as or otherwise support a means for receiving the indication that the UE supports a single measurement gap configuration for reference signal measurements associated with the one or more beam mobility or tracking procedures and reference signal measurements associated with one or more radio resource management procedures.

In some examples, the indication specifies that the single measurement gap configuration is applicable across a set of frequency ranges.

In some examples, to support receiving the indication, the capability interface 1140 may be configured as or otherwise support a means for receiving the indication that the UE supports different measurement gap configurations for reference signal measurements associated with the one or more beam mobility or tracking procedures and for reference signal measurements associated with one or more radio resource management procedures.

In some examples, the indication specifies that the different measurement gap configurations are applicable across a set of frequency ranges.

In some examples, to support receiving the indication, the capability interface 1140 may be configured as or otherwise support a means for receiving the indication that the UE supports a measurement gap configuration for respective frequency ranges of a set of frequency ranges, where the measurement gap configuration applicable to both reference signal measurements associated with the one or more beam mobility or tracking procedures and reference signal measurements associated with one or more radio resource management procedures in the respective frequency range.

In some examples, to support receiving the indication, the capability interface 1140 may be configured as or otherwise support a means for receiving the indication that the UE supports different measurement gap configurations for reference signal measurements associated with the one or more beam mobility or tracking procedures and for reference signal measurements associated with one or more radio resource management procedures and in different frequency ranges of a set of frequency ranges.

In some examples, the L3 configuration interface 1125 may be configured as or otherwise support a means for transmitting signaling identifying a second measurement gap configuration defining a second pattern of measurement occasions for reference signal measurements outside the active bandwidth part for the UE and associated with one or more radio resource management procedures. In some examples, the communication interface 1135 may be configured as or otherwise support a means for communicating with the UE in accordance with the first measurement gap configuration, the second measurement gap configuration, or both, based on a minimum gap separation threshold.

In some examples, reference signal measurements are performed on synchronization signal blocks, channel state information reference signals, or both.

In some examples, to support receiving the UE capability, the capability interface 1140 may be configured as or otherwise support a means for receiving the indication that the UE supports measurement gap configurations differently for the one or more beam mobility and tracking procedures and for one or more radio resource management procedures.

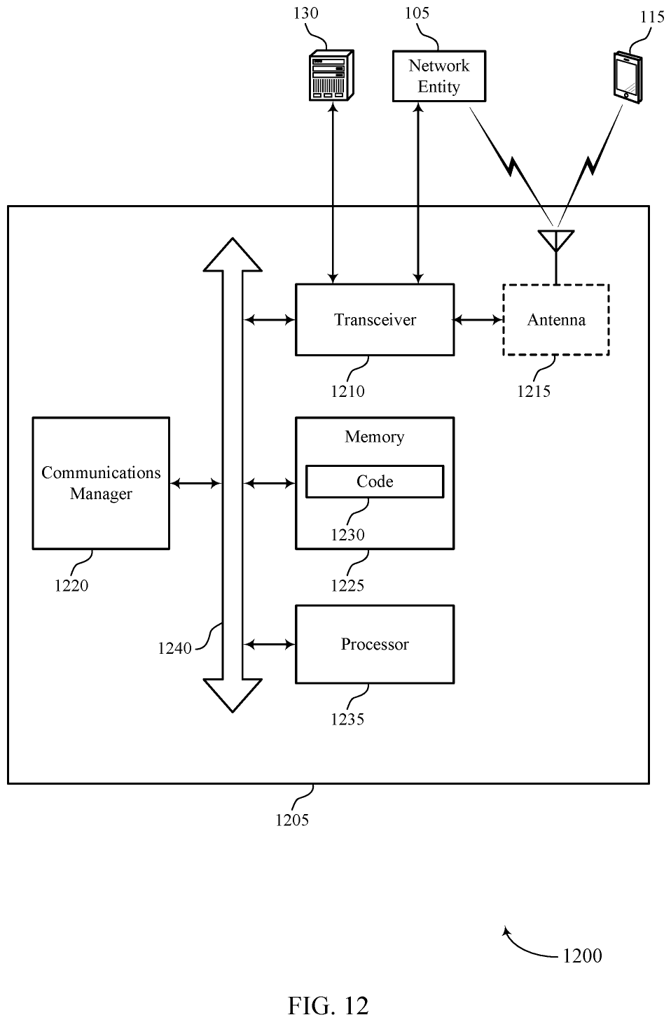

FIG. 12 shows a diagram of a system 1200 including a device 1205 that supports synchronization signal block measurement gaps in multiple layers in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a GPU, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting synchronization signal block measurement gaps in multiple layers). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a base station in accordance with examples as disclosed herein. For example, the communications manager 1220 may be configured as or otherwise support a means for transmitting signaling identifying a first measurement gap configuration defining a first pattern of measurement occasions for reference signal measurements outside an active bandwidth part for the UE and associated with one or more radio resource management procedures. The communications manager 1220 may be configured as or otherwise support a means for transmitting signaling identifying a second measurement gap configuration defining a second pattern of measurement occasions for reference signal measurements outside the active bandwidth part for the UE and associated with one or more beam mobility or tracking procedures. The communications manager 1220 may be configured as or otherwise support a means for communicating with the UE in accordance with the first measurement gap configuration, the second measurement gap configuration, or both, based on a minimum gap separation threshold.

Additionally, or alternatively, the communications manager 1220 may support wireless communication at a base station in accordance with examples as disclosed herein. For example, the communications manager 1220 may be configured as or otherwise support a means for receiving an indication of a UE capability of performing reference signal measurements outside an active bandwidth part for the UE and according to one or more measurement gap configurations, the UE capability corresponding to the reference signal measurements associated with one or more beam mobility or tracking procedures. The communications manager 1220 may be configured as or otherwise support a means for transmitting, based on the UE capability, signaling identifying a first measurement gap configuration defining a first pattern of measurement occasions for reference signal measurements associated with the one or more beam mobility or tracking procedures. The communications manager 1220 may be configured as or otherwise support a means for communicating with the UE based on the first measurement gap configuration.

By including or configuring the communications manager 1220 in accordance with examples as described herein, the device 1205 may support techniques for improved communication reliability by supporting measurements outside an active bandwidth part, which may support identification of beams and/or resources to support communications. As a result, communication resources may be efficiently sued, which may result in reduced latency and longer battery life.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of synchronization signal block measurement gaps in multiple layers as described herein, or the processor 1235 and the memory 1225 may be otherwise configured to perform or support such operations.

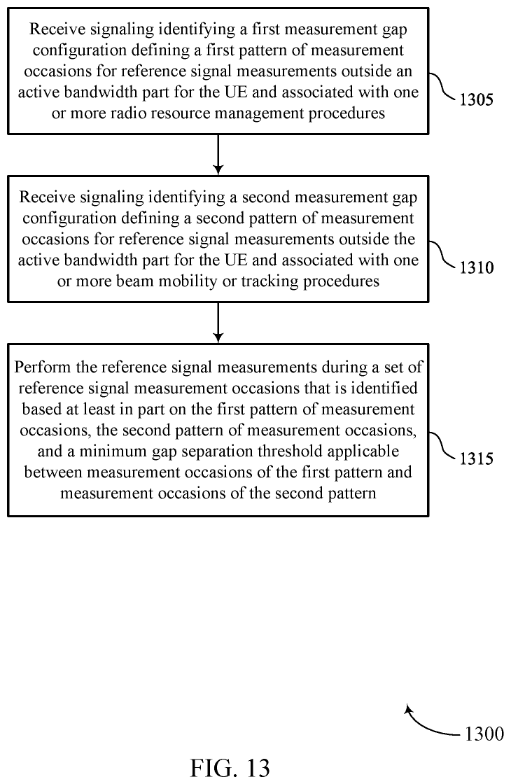

FIG. 13 shows a flowchart illustrating a method 1300 that supports synchronization signal block measurement gaps in multiple layers in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving signaling identifying a first measurement gap configuration defining a first pattern of measurement occasions for reference signal measurements outside an active bandwidth part for the UE and associated with one or more radio resource management procedures. The operations of 1305 may be performed in accordance with examples as disclosed herein. In some examples, aspects of the operations of 1305 may be performed by a L3 measurement gap configuration interface 725 as described with reference to FIG. 7.

At 1310, the method may include receiving signaling identifying a second measurement gap configuration defining a second pattern of measurement occasions for reference signal measurements outside the active bandwidth part for the UE and associated with one or more beam mobility or tracking procedures. The operations of 1310 may be performed in accordance with examples as disclosed herein. In some examples, aspects of the operations of 1310 may be performed by a L1 measurement gap configuration interface 730 as described with reference to FIG. 7.

At 1315, the method may include performing the reference signal measurements during a set of reference signal measurement occasions that is identified based at least in part on the first pattern of measurement occasions, the second pattern of measurement occasions, and a minimum gap separation threshold applicable between measurement occasions of the first pattern and measurement occasions of the second pattern. The operations of 1315 may be performed in accordance with examples as disclosed herein. In some examples, aspects of the operations of 1315 may be performed by a measurement component 735 as described with reference to FIG. 7.

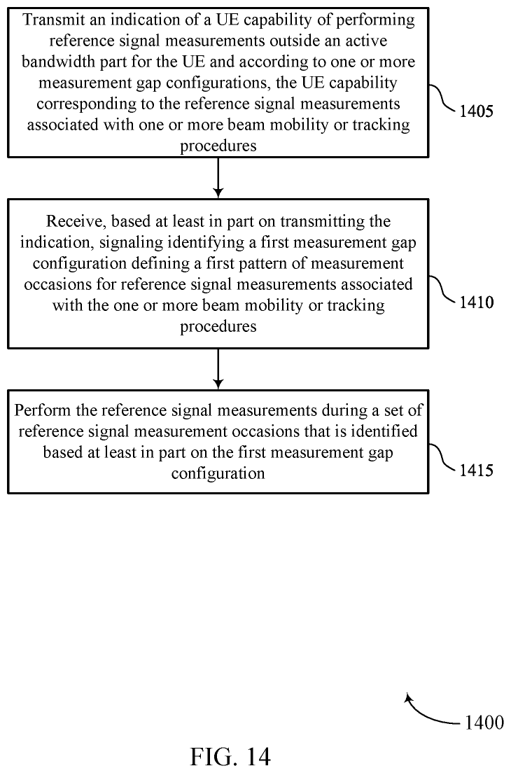

FIG. 14 shows a flowchart illustrating a method 1400 that supports synchronization signal block measurement gaps in multiple layers in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting an indication of a UE capability of performing reference signal measurements outside an active bandwidth part for the UE and according to one or more measurement gap configurations, the UE capability corresponding to the reference signal measurements associated with one or more beam mobility or tracking procedures. The operations of 1405 may be performed in accordance with examples as disclosed herein. In some examples, aspects of the operations of 1405 may be performed by a capability interface 740 as described with reference to FIG. 7.

At 1410, the method may include receiving, based at least in part on transmitting the indication, signaling identifying a first measurement gap configuration defining a first pattern of measurement occasions for reference signal measurements associated with the one or more beam mobility or tracking procedures. The operations of 1410 may be performed in accordance with examples as disclosed herein. In some examples, aspects of the operations of 1410 may be performed by a L1 measurement gap configuration interface 730 as described with reference to FIG. 7.

At 1415, the method may include performing the reference signal measurements during a set of reference signal measurement occasions that is identified based at least in part on the first measurement gap configuration. The operations of 1415 may be performed in accordance with examples as disclosed herein. In some examples, aspects of the operations of 1415 may be performed by a measurement component 735 as described with reference to FIG. 7.

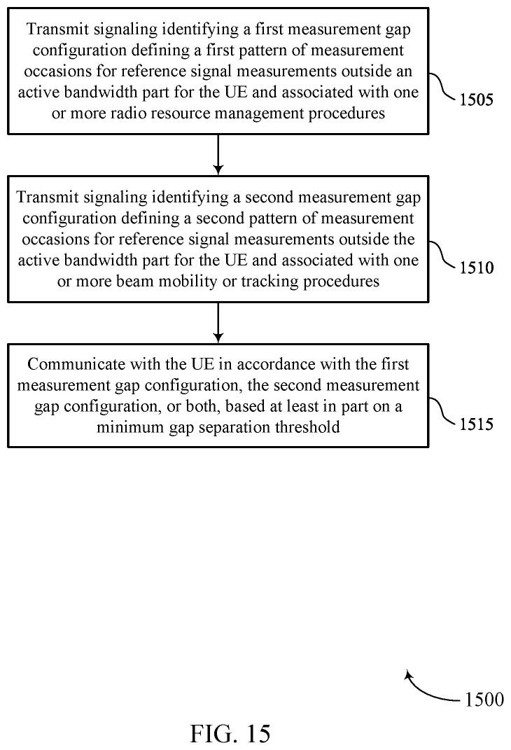

FIG. 15 shows a flowchart illustrating a method 1500 that supports synchronization signal block measurement gaps in multiple layers in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include transmitting signaling identifying a first measurement gap configuration defining a first pattern of measurement occasions for reference signal measurements outside an active bandwidth part for the UE and associated with one or more radio resource management procedures. The operations of 1505 may be performed in accordance with examples as disclosed herein. In some examples, aspects of the operations of 1505 may be performed by a L3 configuration interface 1125 as described with reference to FIG. 11.

At 1510, the method may include transmitting signaling identifying a second measurement gap configuration defining a second pattern of measurement occasions for reference signal measurements outside the active bandwidth part for the UE and associated with one or more beam mobility or tracking procedures. The operations of 1510 may be performed in accordance with examples as disclosed herein. In some examples, aspects of the operations of 1510 may be performed by a L1 configuration interface 1130 as described with reference to FIG. 11.

At 1515, the method may include communicating with the UE in accordance with the first measurement gap configuration, the second measurement gap configuration, or both, based at least in part on a minimum gap separation threshold. The operations of 1515 may be performed in accordance with examples as disclosed herein. In some examples, aspects of the operations of 1515 may be performed by a communication interface 1135 as described with reference to FIG. 11.

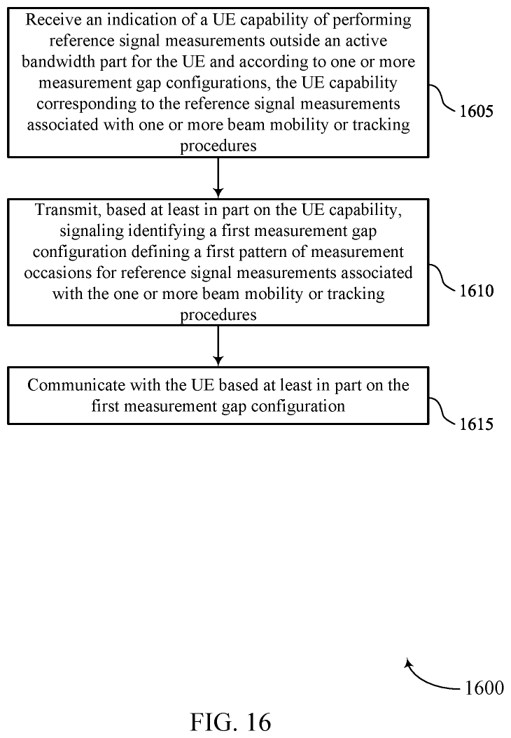

FIG. 16 shows a flowchart illustrating a method 1600 that supports synchronization signal block measurement gaps in multiple layers in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving an indication of a UE capability of performing reference signal measurements outside an active bandwidth part for the UE and according to one or more measurement gap configurations, the UE capability corresponding to the reference signal measurements associated with one or more beam mobility or tracking procedures. The operations of 1605 may be performed in accordance with examples as disclosed herein. In some examples, aspects of the operations of 1605 may be performed by a capability interface 1140 as described with reference to FIG. 11.

At 1610, the method may include transmitting, based at least in part on the UE capability, signaling identifying a first measurement gap configuration defining a first pattern of measurement occasions for reference signal measurements associated with the one or more beam mobility or tracking procedures. The operations of 1610 may be performed in accordance with examples as disclosed herein. In some examples, aspects of the operations of 1610 may be performed by a L1 configuration interface 1130 as described with reference to FIG. 11.

At 1615, the method may include communicating with the UE based at least in part on the first measurement gap configuration. The operations of 1615 may be performed in accordance with examples as disclosed herein. In some examples, aspects of the operations of 1615 may be performed by a communication interface 1135 as described with reference to FIG. 11.

The following provides an overview of aspects of the present disclosure:

Aspect 1: A method for wireless communication at a UE, comprising: receiving signaling identifying a first measurement gap configuration defining a first pattern of measurement occasions for reference signal measurements outside an active bandwidth part for the UE and associated with one or more radio resource management procedures; receiving signaling identifying a second measurement gap configuration defining a second pattern of measurement occasions for reference signal measurements outside the active bandwidth part for the UE and associated with one or more beam mobility or tracking procedures; and performing the reference signal measurements during a set of reference signal measurement occasions that is identified based at least in part on the first pattern of measurement occasions, the second pattern of measurement occasions, and a minimum gap separation threshold applicable between measurement occasions of the first pattern and measurement occasions of the second pattern.

Aspect 2: The method of aspect 1, further comprising: transmitting an indication of a UE capability of performing reference signal measurements outside the active bandwidth part for the UE and according to one or more measurement gap configurations, the UE capability corresponding to the reference signal measurements associated with the one or more beam mobility or tracking procedures, wherein the signaling identifying the first measurement gap configuration, the signaling identifying the second measurement gap configuration, or both, are received based at least in part on transmitting the indication of the UE capability.

Aspect 3: The method of any of aspects 1 through 2, further comprising: performing a reference signal measurement during a first measurement occasion of the first pattern or a second measurement occasion of the second pattern based at least in part on a time separation between the first measurement occasion and the second measurement occasion being less than the minimum gap separation threshold.

Aspect 4: The method of aspect 3, further comprising: selecting either the first measurement occasion or the second measurement occasion for performing the reference signal measurement in accordance with a selection rule that is applied when the time separation is less than the minimum gap separation threshold.

Aspect 5: The method of any of aspects 3 through 4, further comprising: selecting either the first measurement occasion or the second measurement occasion for performing the reference signal measurement in accordance with a first priority associated with the first pattern and a second priority associated with the second pattern.

Aspect 6: The method of any of aspects 3 through 5, further comprising: selecting either the first measurement occasion or the second measurement occasion for performing the reference signal measurement based at least in part on a beam quality of a serving beam, a beam quality of a non-serving beam, a mobility of the UE, channel conditions, or a combination thereof.

Aspect 7: The method of aspect 6, wherein the beam quality of the serving beam, the beam quality of the non-serving beam, or both is based at least in part on one or more combinations of signal-to-noise ratio, reference signal receive power (RSRP), reference signal received quality (RSRQ), layer one reference signal receive power (L1-RSRP), or a combination thereof.

Aspect 8: The method of any of aspects 3 through 7, further comprising: identifying a collision based at least in part on the time separation being less than the minimum gap separation threshold, wherein the reference signal measurement is performed during the first measurement occasion or the second measurement occasion based at least in part on identifying the collision.

Aspect 9: The method of any of aspects 1 through 8, further comprising: receiving signaling that identifies a selection rule that is used by the UE to select, for performing the reference signal measurements, either a first measurement occasion of the first pattern or a second measurement occasion of the second pattern when a time separation between the first measurement occasion and the second measurement occasion is less than the minimum gap separation threshold.

Aspect 10: The method of any of aspects 1 through 9, wherein the minimum gap separation threshold is based at least in part on a measurement occasion periodicity of the first pattern, a measurement occasion periodicity of the second pattern, a measurement occasion length of the first pattern, a measurement occasion length of the second pattern, or a combination thereof.

Aspect 11: The method of any of aspects 1 through 10, wherein the minimum gap separation threshold is based at least in part on a tone spacing, a frequency, a UE capability, or a combination thereof.

Aspect 12: The method of any of aspects 1 through 11, further comprising: receiving signaling indicating the minimum gap separation threshold.

Aspect 13: The method of any of aspects 1 through 12, wherein reference signal measurements are performed on synchronization signal blocks, channel state information reference signals, or both.

Aspect 14: A method for wireless communication at a UE, comprising: transmitting an indication of a UE capability of performing reference signal measurements outside an active bandwidth part for the UE and according to one or more measurement gap configurations, the UE capability corresponding to the reference signal measurements associated with one or more beam mobility or tracking procedures; receiving, based at least in part on transmitting the indication, signaling identifying a first measurement gap configuration defining a first pattern of measurement occasions for reference signal measurements associated with the one or more beam mobility or tracking procedures; and performing the reference signal measurements during a set of reference signal measurement occasions that is identified based at least in part on the first measurement gap configuration.

Aspect 15: The method of aspect 14, wherein transmitting the UE capability comprises: transmitting the indication that the UE supports a single measurement gap configuration for reference signal measurements associated with the one or more beam mobility or tracking procedures and reference signal measurements associated with one or more radio resource management procedures.

Aspect 16: The method of aspect 15, wherein the indication specifies that the single measurement gap configuration is applicable across a set of frequency ranges.

Aspect 17: The method of aspect 14, wherein transmitting the UE capability comprises: transmitting the indication that the UE supports different measurement gap configurations for reference signal measurements associated with the one or more beam mobility or tracking procedures and for reference signal measurements associated with one or more radio resource management procedures.

Aspect 18: The method of aspect 17, wherein the indication specifies that the different measurement gap configurations are applicable across a set of frequency ranges.

Aspect 19: The method of aspect 14, wherein transmitting the UE capability comprises: transmitting the indication that the UE supports a measurement gap configuration for respective frequency ranges of a set of frequency ranges, wherein the measurement gap configuration applicable to both reference signal measurements associated with the one or more beam mobility or tracking procedures and reference signal measurements associated with one or more radio resource management procedures in the respective frequency range.

Aspect 20: The method of aspect 14, wherein transmitting the UE capability comprises: transmitting the indication that the UE supports different measurement gap configurations for reference signal measurements associated with the one or more beam mobility or tracking procedures and for reference signal measurements associated with one or more radio resource management procedures and in different frequency ranges of a set of frequency ranges.

Aspect 21: The method of any of aspects 14 through 20, further comprising: receiving signaling identifying a second measurement gap configuration defining a second pattern of measurement occasions for reference signal measurements outside the active bandwidth part for the UE and associated with one or more radio resource management procedures; and performing the reference signal measurements during a set of reference signal measurement occasions that is identified based at least in part on the first pattern of measurement occasions, the second pattern of measurement occasions, and a minimum gap separation threshold applicable between measurement occasions of the first pattern and measurement occasions of the second pattern.

Aspect 22: The method of aspect 14, wherein transmitting the UE capability comprises: transmitting the indication that the UE supports measurement gap configurations differently for the one or more beam mobility and tracking procedures and for one or more radio resource management procedures.

Aspect 23: The method of any of aspects 14 through 22, wherein reference signal measurements are performed on synchronization signal blocks, channel state information reference signals, or both.

Aspect 24: A method for wireless communications at a network entity, comprising: transmitting signaling identifying a first measurement gap configuration defining a first pattern of measurement occasions for reference signal measurements outside an active bandwidth part for a UE and associated with one or more radio resource management procedures; transmitting signaling identifying a second measurement gap configuration defining a second pattern of measurement occasions for reference signal measurements outside the active bandwidth part for the UE and associated with one or more beam mobility or tracking procedures; and communicating with the UE in accordance with the first measurement gap configuration, the second measurement gap configuration, or both, based at least in part on a minimum gap separation threshold.

Aspect 25: The method of aspect 24, further comprising: receiving an indication of a UE capability of performing reference signal measurements outside the active bandwidth part for the UE and according to one or more measurement gap configurations, the UE capability corresponding to the reference signal measurements associated with the one or more beam mobility or tracking procedures, wherein the signaling identifying the first measurement gap configuration, the signaling identifying the second measurement gap configuration, or both, are transmitted based at least in part on transmitting the indication of the UE capability.

Aspect 26: The method of any of aspects 24 through 25, further comprising: transmitting signaling that identifies a selection rule that is used by the UE to select, for performing a reference signal measurement, either a first measurement occasion of the first pattern or a second measurement occasion of the second pattern when a time separation between the first measurement occasion and the second measurement occasion is less than the minimum gap separation threshold.

Aspect 27: The method of aspect 26, wherein the selection rule specifies that the UE is to use a first priority associated with the first pattern and a second priority associated with the second pattern in selecting between the first measurement occasion and the second measurement occasion for performing the reference signal measurement.

Aspect 28: The method of any of aspects 26 through 27, wherein the selection rule specifies that the UE is to use a beam quality of a serving beam, a beam quality of a non-serving beam, a mobility of the UE, a channel condition, or a combination thereof, for selecting between the first measurement occasion and the second measurement occasion for performing the reference signal measurement.

Aspect 29: The method of any of aspects 24 through 28, further comprising: identifying a collision between a first measurement occasion of the first pattern and a second measurement occasion of the second pattern based at least in part on a time separation between the first measurement occasion and the second measurement occasion being less than the minimum gap separation threshold.

Aspect 30: The method of any of aspects 24 through 29, wherein the minimum gap separation threshold is based at least in part on a measurement occasion periodicity of the first pattern, a measurement occasion periodicity of the second pattern, a measurement occasion length of the first pattern, a measurement occasion length of the second pattern, or a combination thereof.

Aspect 31: The method of any of aspects 24 through 30, further comprising: transmitting signaling indicating the minimum gap separation threshold.

Aspect 32: The method of any of aspects 24 through 31, wherein the minimum gap separation threshold is based at least in part on a tone spacing, a frequency, a UE capability, or a combination thereof.

Aspect 33: The method of any of aspects 24 through 32, wherein reference signal measurements are performed on synchronization signal blocks, channel state information reference signals, or both.

Aspect 34: A method for wireless communication at a network entity, comprising: receiving an indication of a UE capability of performing reference signal measurements outside an active bandwidth part for the UE and according to one or more measurement gap configurations, the UE capability corresponding to the reference signal measurements associated with one or more beam mobility or tracking procedures; transmitting, based at least in part on the UE capability, signaling identifying a first measurement gap configuration defining a first pattern of measurement occasions for reference signal measurements associated with the one or more beam mobility or tracking procedures; and communicating with the UE based at least in part on the first measurement gap configuration.

Aspect 35: The method of aspect 34, wherein receiving the indication comprises: receiving the indication that the UE supports a single measurement gap configuration for reference signal measurements associated with the one or more beam mobility or tracking procedures and reference signal measurements associated with one or more radio resource management procedures.

Aspect 36: The method of aspect 35, wherein the indication specifies that the single measurement gap configuration is applicable across a set of frequency ranges.

Aspect 37: The method of aspect 34, wherein receiving the indication comprises: receiving the indication that the UE supports different measurement gap configurations for reference signal measurements associated with the one or more beam mobility or tracking procedures and for reference signal measurements associated with one or more radio resource management procedures.

Aspect 38: The method of aspect 37, wherein the indication specifies that the different measurement gap configurations are applicable across a set of frequency ranges.

Aspect 39: The method of aspect 34, wherein receiving the indication comprises: receiving the indication that the UE supports a measurement gap configuration for respective frequency ranges of a set of frequency ranges, wherein the measurement gap configuration applicable to both reference signal measurements associated with the one or more beam mobility or tracking procedures and reference signal measurements associated with one or more radio resource management procedures in the respective frequency range.

Aspect 40: The method of aspect 34, wherein receiving the indication comprises: receiving the indication that the UE supports different measurement gap configurations for reference signal measurements associated with the one or more beam mobility or tracking procedures and for reference signal measurements associated with one or more radio resource management procedures and in different frequency ranges of a set of frequency ranges.

Aspect 41: The method of any of aspects 34 through 40, further comprising: transmitting signaling identifying a second measurement gap configuration defining a second pattern of measurement occasions for reference signal measurements outside the active bandwidth part for the UE and associated with one or more radio resource management procedures; and communicating with the UE in accordance with the first measurement gap configuration, the second measurement gap configuration, or both, based at least in part on a minimum gap separation threshold.

Aspect 42: The method of any of aspects 34 through 41, wherein reference signal measurements are performed on synchronization signal blocks, channel state information reference signals, or both.

Aspect 43: The method of aspect 34, wherein receiving the UE capability comprises: receiving the indication that the UE supports measurement gap configurations differently for the one or more beam mobility and tracking procedures and for one or more radio resource management procedures.

Aspect 44: An apparatus for wireless communication at a UE, comprising at least one processor; memory coupled with the at least one processor; the memory storing instructions executable by the at least one processor to cause the UE to perform a method of any of aspects 1 through 13.

Aspect 45: An apparatus for wireless communication at a UE, comprising at least one means for performing a method of any of aspects 1 through 13.

Aspect 46: A non-transitory computer-readable medium storing code for wireless communication at a UE, the code comprising instructions executable by at least one processor to perform a method of any of aspects 1 through 13.

Aspect 47: An apparatus for wireless communication at a UE, comprising at least one processor; memory coupled with the at least one processor, the memory storing instructions executable by the at least one processor to cause the UE to perform a method of any of aspects 14 through 23.

Aspect 48: An apparatus for wireless communication at a UE, comprising at least one means for performing a method of any of aspects 14 through 23.

Aspect 49: A non-transitory computer-readable medium storing code for wireless communication at a UE, the code comprising instructions executable by at least one processor to perform a method of any of aspects 14 through 23.

Aspect 50: An apparatus for wireless communications at a network entity, comprising at least one processor; memory coupled with the at least one processor, the memory storing instructions executable by the at least one processor to cause the network entity to perform a method of any of aspects 24 through 33.

Aspect 51: An apparatus for wireless communications at a network entity, comprising at least one means for performing a method of any of aspects 24 through 33.

Aspect 52: A non-transitory computer-readable medium storing code for wireless communications at a network entity, the code comprising instructions executable by at least one processor to perform a method of any of aspects 24 through 33.

Aspect 53: An apparatus for wireless communication at a network entity, comprising at least one processor; memory coupled with the at least one processor, the memory storing instructions executable by the at least one processor to cause the network entity to perform a method of any of aspects 34 through 43.

Aspect 54: An apparatus for wireless communication at a network entity, comprising at least one means for performing a method of any of aspects 34 through 43.

Aspect 55: A non-transitory computer-readable medium storing code for wireless communication at a network entity, the code comprising instructions executable by at least one processor to perform a method of any of aspects 34 through 43.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, a GPU, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination

The term “determine” or “determining” encompasses a variety of actions and, therefore, “determining” can include calculating, computing, processing, deriving, investigating, looking up (such as via looking up in a table, a database or another data structure), and ascertaining. Also, “determining” can include receiving (such as receiving information), and accessing (such as accessing data in a memory). Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a user equipment (UE), comprising:
receiving signaling identifying a first measurement gap configuration defining a first pattern of measurement occasions for reference signal measurements outside an active bandwidth part for the UE;
receiving signaling identifying a second measurement gap configuration defining a second pattern of measurement occasions for reference signal measurements outside the active bandwidth part for the UE; and
performing the reference signal measurements during a set of reference signal measurement occasions that is identified based at least in part on the first pattern of measurement occasions, the second pattern of measurement occasions, and a minimum gap separation threshold applicable between measurement occasions of the first pattern and measurement occasions of the second pattern.

2. The method of claim 1, further comprising:
transmitting an indication of a UE capability of performing reference signal measurements outside the active bandwidth part for the UE and according to one or more measurement gap configurations, the UE capability corresponding to the reference signal measurements associated with one or more beam mobility or tracking procedures, wherein the signaling identifying the first measurement gap configuration, the signaling identifying the second measurement gap configuration, or both, are received based at least in part on transmitting the indication of the UE capability.

3. The method of claim 1, further comprising:
performing a reference signal measurement during a first measurement occasion of the first pattern or a second measurement occasion of the second pattern based at least in part on a time separation between the first measurement occasion and the second measurement occasion being less than the minimum gap separation threshold.

4-13. (canceled)

14. A method for wireless communication at a user equipment (UE), comprising:
transmitting an indication of a UE capability of performing reference signal measurements outside an active bandwidth part for the UE and according to one or more measurement gap configurations, the UE capability corresponding to the reference signal measurements associated with one or more beam mobility or tracking procedures;
receiving, based at least in part on transmitting the indication, signaling identifying a first measurement gap configuration defining a first pattern of measurement occasions for reference signal measurements associated with the one or more beam mobility or tracking procedures; and
performing the reference signal measurements during a set of reference signal measurement occasions that is identified based at least in part on the first measurement gap configuration.

15. The method of claim 14, wherein transmitting the UE capability comprises:
transmitting the indication that the UE supports a single measurement gap configuration for reference signal measurements associated with the one or more beam mobility or tracking procedures and reference signal measurements associated with one or more radio resource management procedures.

16-43. (canceled)

44. An apparatus for wireless communication at a user equipment (UE), comprising:
at least one processor; and
memory coupled with the at least one processor, the memory storing instructions executable by the at least one processor to cause the UE to:
receive signaling identifying a first measurement gap configuration defining a first pattern of measurement occasions for reference signal measurements outside an active bandwidth part for the UE;
receive signaling identifying a second measurement gap configuration defining a second pattern of measurement occasions for reference signal measurements outside the active bandwidth part for the UE; and
perform the reference signal measurements during a set of reference signal measurement occasions that is identified based at least in part on the first pattern of measurement occasions, the second pattern of measurement occasions, and a minimum gap separation threshold applicable between measurement occasions of the first pattern and measurement occasions of the second pattern.

45. The apparatus of claim 44, wherein the instructions are further executable by the at least one processor to cause the UE to:
transmit an indication of a UE capability of performing reference signal measurements outside the active bandwidth part for the UE and according to one or more measurement gap configurations, the UE capability corresponding to the reference signal measurements associated with one or more beam mobility or tracking procedures, wherein the signaling identifying the first measurement gap configuration, the signaling identifying the second measurement gap configuration, or both, are received based at least in part on transmitting the indication of the UE capability.

46. The apparatus of claim 44, wherein the instructions are further executable by the at least one processor to cause the UE to:
perform a reference signal measurement during a first measurement occasion of the first pattern or a second measurement occasion of the second pattern based at least in part on a time separation between the first measurement occasion and the second measurement occasion being less than the minimum gap separation threshold.

47. The apparatus of claim 46, wherein the instructions are further executable by the at least one processor to cause the UE to:
select either the first measurement occasion or the second measurement occasion for performing the reference signal measurement in accordance with a selection rule that is applied when the time separation is less than the minimum gap separation threshold.

48. The apparatus of claim 46, wherein the instructions are further executable by the at least one processor to cause the UE to:
select either the first measurement occasion or the second measurement occasion for performing the reference signal measurement in accordance with a first priority associated with the first pattern and a second priority associated with the second pattern.

49. The apparatus of claim 46, wherein the instructions are further executable by the at least one processor to cause the UE to:
select either the first measurement occasion or the second measurement occasion for performing the reference signal measurement based at least in part on a beam quality of a serving beam, a beam quality of a non-serving beam, a mobility of the UE, channel conditions, or a combination thereof.

50. The apparatus of claim 49, wherein the beam quality of the serving beam, the beam quality of the non-serving beam, or both is based at least in part on one or more combinations of signal-to-noise ratio, reference signal receive power (RSRP), reference signal received quality (RSRQ), layer one reference signal receive power (L1-RSRP), or a combination thereof.

51. The apparatus of claim 46, wherein the instructions are further executable by the at least one processor to cause the UE to:
identify a collision based at least in part on the time separation being less than the minimum gap separation threshold, wherein the reference signal measurement is performed during the first measurement occasion or the second measurement occasion based at least in part on identifying the collision.

52. The apparatus of claim 44, wherein the instructions are further executable by the at least one processor to cause the UE to:
receive signaling that identifies a selection rule that is used by the UE to select, for performing the reference signal measurements, either a first measurement occasion of the first pattern or a second measurement occasion of the second pattern when a time separation between the first measurement occasion and the second measurement occasion is less than the minimum gap separation threshold.

53. The apparatus of claim 44, wherein the minimum gap separation threshold is based at least in part on a measurement occasion periodicity of the first pattern, a measurement occasion periodicity of the second pattern, a measurement occasion length of the first pattern, a measurement occasion length of the second pattern, or a combination thereof.

54. The apparatus of claim 44, wherein the minimum gap separation threshold is based at least in part on a tone spacing, a frequency, a UE capability, or a combination thereof.

55. The apparatus of claim 44, wherein the instructions are further executable by the at least one processor to cause the UE to:
receive signaling indicating the minimum gap separation threshold.

56. The apparatus of claim 44, wherein the reference signal measurements are performed on synchronization signal blocks, channel state information reference signals, or both.

57. An apparatus for wireless communication at a user equipment (UE), comprising:
at least one processor; and
memory coupled with the at least one processor, the memory storing instructions executable by the at least one processor to cause the UE to:
transmit an indication of a UE capability of performing reference signal measurements outside an active bandwidth part for the UE and according to one or more measurement gap configurations, the UE capability corresponding to the reference signal measurements associated with one or more beam mobility or tracking procedures;
receive, based at least in part on transmitting the indication, signaling identifying a first measurement gap configuration defining a first pattern of measurement occasions for reference signal measurements associated with the one or more beam mobility or tracking procedures; and
perform the reference signal measurements during a set of reference signal measurement occasions that is identified based at least in part on the first measurement gap configuration.

58. The apparatus of claim 57, wherein the instructions to transmit the UE capability are executable by the at least one processor to cause the UE to:
transmit the indication that the UE supports a single measurement gap configuration for reference signal measurements associated with the one or more beam mobility or tracking procedures and reference signal measurements associated with one or more radio resource management procedures.

59. The apparatus of claim 58, wherein the indication specifies that the single measurement gap configuration is applicable across a set of frequency ranges.

60. The apparatus of claim 57, wherein the instructions to transmit the UE capability are executable by the at least one processor to cause the UE to:
transmit the indication that the UE supports different measurement gap configurations for reference signal measurements associated with the one or more beam mobility or tracking procedures and for reference signal measurements associated with one or more radio resource management procedures.

61. The apparatus of claim 60, wherein the indication specifies that the different measurement gap configurations are applicable across a set of frequency ranges.

62. The apparatus of claim 57, wherein the instructions to transmit the UE capability are executable by the at least one processor to cause the UE to:
transmit the indication that the UE supports a measurement gap configuration for respective frequency ranges of a set of frequency ranges, wherein the measurement gap configuration applicable to both reference signal measurements associated with the one or more beam mobility or tracking procedures and reference signal measurements associated with one or more radio resource management procedures in the respective frequency range.

63. The apparatus of claim 57, wherein the instructions to transmit the UE capability are executable by the at least one processor to cause the UE to:
transmit the indication that the UE supports different measurement gap configurations for reference signal measurements associated with the one or more beam mobility or tracking procedures and for reference signal measurements associated with one or more radio resource management procedures and in different frequency ranges of a set of frequency ranges.

64. The apparatus of claim 57, wherein the instructions are further executable by the at least one processor to cause the UE to:
receive signaling identifying a second measurement gap configuration defining a second pattern of measurement occasions for reference signal measurements outside the active bandwidth part for the UE and associated with one or more radio resource management procedures; and
perform the reference signal measurements during a set of reference signal measurement occasions that is identified based at least in part on the first pattern of measurement occasions, the second pattern of measurement occasions, and a minimum gap separation threshold applicable between measurement occasions of the first pattern and measurement occasions of the second pattern.

65. The apparatus of claim 57, wherein the instructions to transmit the UE capability are executable by the at least one processor to cause the UE to:
transmit the indication that the UE supports measurement gap configurations differently for the one or more beam mobility or tracking procedures and for one or more radio resource management procedures.

66. The apparatus of claim 57, wherein reference signal measurements are performed on synchronization signal blocks, channel state information reference signals, or both.

67-215. (canceled)

216. The method of claim 1, wherein the first pattern of measurement occasions for reference signal measurements outside the active bandwidth part for the UE is associated with one or more radio resource management procedures and the second pattern of measurement occasions for reference signal measurements outside the active bandwidth part for the UE is associated with one or more beam mobility or tracking procedures.

217. The apparatus of claim 44, wherein the first pattern of measurement occasions for reference signal measurements outside the active bandwidth part for the UE is associated with one or more radio resource management procedures and the second pattern of measurement occasions for reference signal measurements outside the active bandwidth part for the UE is associated with one or more beam mobility or tracking procedures.
